(19) United States
(12) Patent Application Publication
(10) Pub. No.: US 2012/0160042 A1
(43) Pub. Date: Jun. 28, 2012

(54) LINEAR DRIVE MECHANISM

(76) Inventors: Stefan Stanev, Gardena, CA (US); Roger Heinz, Gardena, CA (US)

(21) Appl. No.: 12/979,241

(22) Filed: Dec. 27, 2010

(51) Int. Cl. F16H 29/02

(52) U.S. Cl. 74/89.21; 74/89.2

(57) ABSTRACT

A linear drive mechanism includes first and second tapes formed of resilient material that each have an inner surface, a parallel outer surface, a first end, a second end and a concave/convex cross-section. A first tape guide has first and second guide slots that are sized and shaped to fit slidably about the first and second tapes and located to position the outer surfaces of the tapes adjacent one another. At least one second tape guide has third and fourth guide slots that are sized and shaped to fit slidably about the tapes. The tapes are connected together adjacent their first ends. A drive system has a mounting for the first tape guide that locates it orthogonal to lengths of the tapes. The drive system has rolled storage for the tapes and driving members for extending and retracting the tapes through the first and at least one second tape guide.

### FIELD OF INVENTION

This invention relates to the field of extendable members and more specifically to a linear drive mechanism for use with photographic, audio and other equipment.

### BACKGROUND OF THE INVENTION

Telescoping rods and shafts and other linear drive mechanisms have been employed in many applications. These range from small antennae systems to giant cranes for the erection of buildings. The telescoping shafts may have round, square, triangular or other cross-sectional shapes. The smaller telescoping rod systems are often extended manually. This, however, is impractical for larger systems or those that must be capable of remote operation. Typical powered linear drive systems utilize electric motors and flexible rack gears driven by a pinion gear or pressurized hydraulic cylinders to extend and retract the telescopic sections of the shaft. The rack and pinion systems are often delicate and incapable of handling heavy loads. Hydraulic systems, while more robust, require a compressor, fluid lines and a series of high pressure seals. These components are expensive and require substantial on-going maintenance A variety of other systems have been developed to address these problems. The present invention addresses this problem and also provides additional benefits.

U.S. Pat. No. 4,575,976, issued to McDermott et al., discloses an extension and retraction system for a multiple section, telescoping boom apparatus of the type utilized for raising and lowering a work platform or basket. The innermost longitudinally movable section is carried by a longitudinally inextensible or base section, and is extensible and retractable relative to the base section by a dual cylinder assembly. Extension chains trained about sprockets carried by certain of the sections automatically extend the other extensible sections upon extension by the cylinder assembly of the innermost longitudinally movable section. Automatic and positive retraction of such sections is accomplished by retraction chains operating in response to retraction of the innermost section. The cylinders of the dual cylinder assembly are pivotally coupled at a pivot mount longitudinally slidable along a guideway carried by the base section to thereby accommodate deflections of the boom sections located between the opposite extremities of the dual cylinder assembly. A feature of the apparatus is use of slide pads disposed between the boom sections to transmit loads, the pads being configured to accomplish this with minimum wear.

U.S. Pat. No. 4,643,299, issued to Calundan, is directed to a telescopic conveyor comprises a fixed housing which is open at one end through which a number, as for instance two, three or more, lengthy and belt carrying units arranged above each other are extendably and retractably and slidably mounted within the housing to be slit out from the housing, whereby the lower slidable units at the outer end comprise supporting means for carrying the slidable units positioned above and whereby each of the slidable units comprise at least two belt rollers or drums of which one is positioned foremost at each of the units and whereby furthermore a telescopic drive unit is contained within the conveyor comprising one or more drive belts or drive chains with the ends of each drive belt or drive chain being connected in one end to the fixed and in the other end to the uppermost slidable unit so that at least one of the drive belts or the drive chains are driven by a drive roller or drum respectively by a sprocket. The housing may be of the hoistable kind being carried by a hoisting device or may be f.i. of the hinged kind, being hinged unto a supporting stand or unto a rollable cart. Comprising one common conveyor belt, this belt and the telescopic drive may be controlled from a front end control box.

U.S. Pat. No. 5,695,082, issued to Rainwater illustrates a crane apparatus includes an upstanding mainframe and a boom unit supported for pivoting movement on the mainframe about a horizontal axis. The boom unit includes a base boom, an outer boom section of one or more outer booms, and a fluid-actuated piston-and-cylinder assembly. A pair of space mounting walls is presented by the base boom in which a hole is defined, and the piston-and-cylinder assembly includes a proximal transverse sleeve sized for receipt between the spaced walls of the base boom in alignment with the hole. A pin is provided that is sized for receipt in the hole and the tubular sleeve for securing the piston-and-cylinder assembly to the base boom. Removal of the pin enables the outer boom section and piston-and-cylinder assembly to be removed from the base boom.

U.S. Pat. No. 4,392,573, issued to Gyomrey disclose a telescopic strut jib crane includes a jib with at least three telescopic sections and at least one tie rope of fixed length. The rope is fed between the head of the base section and head of the outer section around a pulley at the foot of an intermediate telescopic jib section. One end of the tie rope passes around a support pulley to the rear of the jib around first extension pulley at the head of the outermost jib section, down the outermost jib section, around a second extension pulley at the foot of the outermost section, to be anchored at or adjacent the head of the intermediate jib section. The other end of the tie rope extends from the support pulley around a third extension pulley at the head of the intermediate section, down the intermediate section and around fourth extension pulley at the base of said intermediate section, and then to the head of the adjacent lower section.

U.S. Pat. No. 5,820,088, issued to Chapman is directed to a camera pedestal has a cylinder with a tapering cross-section for providing a uniform counterbalancing force using a compressed gas. Telescoping column sections which make up a column assembly have inner relief channels and outer slots for hardened roller strips. A column drive system has a hydraulic actuator to remotely raise the column assembly, and to lock the column assembly into any selected position. The column assembly is eccentrically positioned on its base tank. The pedestal is engageable to a receptacle on a camera dolly with a telescoping steering drive tube interconnecting a steering assembly on the pedestal with a steering system in the dolly.

U.S. Pat. No. 4,337,845, issued to Zelli et al. discloses a telescopic elevator device for dollies comprising in combination a wheel-mounted base member, a first extension member telescopically slidable on the base member, a second extension member telescopically mounted within the first extension member and apparatus for controlling the contemporaneous sliding of the extension members with respect to the base with a different speed so that the second extension member has a sliding speed which is the double of the first one.

U.S. Pat. No. 4,847,629, issued to Shimazaki discloses an antenna assembly for use on a vehicle includes telescoping radiating sections that collapse toward an insulated mounting base, so that the radiating sections can be selectively extended. An impedance matching network with concentric outer and inner conductive tubular members slidably receives the telescopically collapsed radiating sections. Both tubular members are attached to the mounting base and electrically insulated therefrom and from each other. The inner tubular member is electrically connected to the radiating sections at a base end thereof. The outer tubular member has at least one longitudinal slot therein through which the central conductor of a transmission line is connected to the inner member. A ground contact is electrically connected to the outer tubular member. A slidable terminal that is selectively adjustable longitudinally along the outer tubular member is connected to the transmission line to select a signal insertion point.

U.S. Pat. No. 4,864,322, issued to Yamamoto et al. discloses an antenna rod, which is extendible and retractable, is moved up and down by a cable with a rack, and the cable is moved with rotation of a pinion gear. The rotational force of a DC motor is transferred to the pinion gear by a route of a worm, a worm wheel, gears, a damper gear, and a damper. The damper is a coil of resilient metal wire, and both ends of the coiled wire, respectively, engage stopping members, which are provided at the center portions of the damper gear and the pinion gear. When the pinion gear is at a standstill, the rotational energy of the damper gear is accumulated in the damper. The motor is rotated under control of a control circuit in response to the operation of a switch. The drive current for the motor is shut off by a detecting signal from a lock detector during the course of accumulating the rotational energy by the damper. The lead angle of the teeth of the worm is large so that the rotational energy stored in the damper is transferred to the motor.

U.S. Pat. No. 5,189,435, issued to Yarsunas et al. discloses a retractable motorized multi-band antenna is adapted to receive signals in the AM/FM bands and to receive and transmit signals in a significantly higher frequency band such as that used for cellular telephone. In order to transfer the coaxial input signal to an output coaxial connector, a slip ring connector is provided. The slip ring connector is impedance matched to the antenna to create low VSWR at RF frequencies.

It is an objective of the present invention to provide a robust linear drive mechanism for telescopic extension of a rod or shaft and related applications. It is a further objective to provide such a device that does not require hydraulic fluid, seals or a compressor. It is a still further objective of the invention to provide an extension system that provides substantial strength in compression. It is yet a further objective to provide such a device that requires only occasional lubrication or maintenance. Finally, it is an objective of the present invention to provide a linear drive mechanism that can be powered electrically or manually and is durable, inexpensive and simple to use.

While some of the objectives of the present invention are disclosed in the prior art, none of the inventions found include all of the requirements identified.

### SUMMARY OF THE INVENTION

The present invention addresses all of the deficiencies of prior art linear drive mechanism inventions and satisfies all of the objectives described above.

1) A linear drive mechanism providing the desired features may be constructed from the following components. A first tape is provided. The first tape is formed of resilient material, has a first inner surface, a parallel first outer surface, a first length, a first near side edge, a first far side edge, a first end, a second end and a first concave/convex cross-section. A second tape is provided. The second tape is formed of resilient material, has a second inner surface, a parallel second outer surface, a second length, a second near side edge, a second far side edge, a proximal end, a distal end and a second concave/convex cross-section. A first tape guide is provided. The first tape guide has first and second guide slots. The first and second slots are sized and shaped to fit slidably about the first and second tapes and located to position the first outer surface adjacent the second outer surface. At least one second tape guide is provided. The second tape guide has third and fourth guide slots. The third and fourth slots are sized and shaped to fit slidably about the first and second tapes and located to position the first outer surface adjacent the second outer surface. The first tape is connected adjacent the first end to the second tape adjacent the distal end.

A drive system is provided. The drive system has a mounting for the first tape guide. The mounting locates the first tape guide orthogonal to first and second lengths of the first and second tapes, respectively. The drive system has rolled storage for the first and second tapes and has driving members for extending and retracting the first and second tapes through the first and at least one second tape guide. The first and second tapes are directed through the first tape guide and the at least one second tape guides and are extended or retracted by the drive system.

2) In a variant of the invention, an external tubing member is provided. The external member has a first end and a second end. The second end is sized and shaped to attach to the drive system. A series of nested internal tubing members is provided. Each of the internal members has a proximal end and a distal end. The proximal end of a largest of the internal tubing members is restricted from passing through the first end of the external tubing member. The proximal end of each succeeding smaller internal tubing member is restricted from passing through the distal end of an internal tubing member within which it is immediately nested. One of the at least one second tape guides is centrally attached adjacent either the proximal end or the distal end. An end cap is provided. The end cap is attached to either a proximal end or a distal end of a smallest of the internal tubing members and attaches to at least one of the first end of the first tape and the distal end of the second tape. At least one of the first and second tapes urges the end cap either toward or away from the drive system as the first and second tapes are either extended or retracted. The end cap either extends or retracts the at least one internal tubing member from the external tubing member and the drive system.

(3) In another variant, a first sleeve bearing is provided. The first sleeve bearing is located adjacent the first end of the external tubing member, is sized and shaped to fit slidably about the largest internal tubing member and has a first internal diameter. At least one base bearing is provided. The base bearing is located adjacent the proximal end of the internal tubing member, is sized and shaped to fit slidably within either of the external tubing member and a preceding, larger internal tubing member within which the internal tubing member is immediately nested. At least one second sleeve bearing is provided. The second sleeve bearing is located adjacent the distal end of the internal tubing member, is sized and shaped to fit slidably about a subsequent, smaller internal tubing member nested immediately within the internal tubing member and has an internal diameter.

The base bearing has an external diameter larger than either the first internal diameter or the internal diameter of the second sleeve bearing of the internal tubing member within which the subsequent, smaller internal tubing member to which the base bearing is attached is immediately nested. The first and second sleeve bearings and the base bearings prevent disassembly of the external tubing member and the series of nested internal tubing members during extension of the first and second tapes from the drive mechanism.

4) In still another variant, one of the at least one second tape guides is centrally attached to the base bearing.

5) In yet another variant the drive system further includes a drive base. The drive base provides a bearing surface for the linear drive mechanism. A first tape reel is provided. The first reel is mounted on a first bearing in the drive base and provides the rolled storage for the first tape. A second tape reel is provided. The second reel is mounted on a second bearing in the drive base and provides the rolled storage for the second tape. A drive roller assembly is provided. The drive roller assembly is located within the drive base adjacent the first tape reel, has a first drive surface engaging the first inner surface and is driven in either a first or a second rotational direction by a drive motor.

An idler roller assembly is provided. The idler roller assembly is located within the drive base, has a second drive surface engaging the second inner surface and is movable toward and away from the second inner surface. The driving members include the drive roller assembly, idler roller assembly and the drive motor.

6) In a further variant, the idler roller assembly further includes a roller support body. The support body has an axel upon which an idler roller is rotatably mounted. A compression spring is provided. The compression spring urges the support body toward the second inner surface. An adjusting screw threadedly engages either the support body or the drive base. The adjusting screw varies preloading of the compression spring.

7) In still a further variant, a first tape support is provided. The first support is attached to the drive base adjacent the second reel and provides a bearing surface adjacent the first inner surface. The first tape support prevents buckling of the first tape under load.

8) In yet a further variant, the first and second drive surfaces are formed of resilient material selected from the group that includes rubber, silicone, plastic, leather and fabric.

9) In another variant of the invention, the first tape further includes a series of uniform sprocket holes adjacent at least one of the first near side edge and the first far side edge.

10) In still another variant, the first drive surface further includes at least one series of uniform sprocket projections. The sprocket projections are sized, shaped and located to engage the sprocket holes in the first tape.

11) In yet another variant, the second drive surface includes at least one of either a series of uniform sprocket detents or a receiving groove. The sprocket detents and the groove are sized, shaped and located to receive the at least one series of uniform sprocket projections.

12) In a further variant, the linear drive mechanism further includes at least one expandable bellows section. The bellows section is formed of resilient material and has a proximal end, a distal end and a central axis. At least one of the expandable bellows sections has one of the second tape guides attached at one of the proximal end and the distal end. The first and second tapes extend from the drive system through the at least one expandable bellows section along the central axis and at least one of said first and second tapes urges either expansion or contraction of the bellows section upon either extension or retraction of the first and second tapes from the drive system.

13) In still a further variant, the linear drive mechanism further includes a tubing section. The tubing section has a hollow bore, a proximal end, a distal end and is attached at the proximal end to the drive system. A piston is provided. The piston has an inner face and an outer face, is sized, shaped and located to fit sealably within the hollow bore and is attached at the inner face to at least one of the second end of the first tape and the distal end of the second tape. At least one stabilizer is provided. The stabilizer has an aperture and an attachment point and is sized, shaped and located to fit slidably within the hollow bore and has one of the at least one second tape guides attached so as to orient the stabilizer orthogonally to the first and second tapes and to the hollow bore.

A spacing member is provided. The spacing member has an outboard end and an inboard end and is attached at the outboard end to either of the inner face of the piston and the attachment point of the at least one stabilizer. The spacing member is sized, shaped and located to pass slidably through the aperture in another of the at least one stabilizer and has a stopping portion at the inboard end. The stopping portion prevents the inboard end from passing through the aperture. The first and second tapes extend from the drive system through the at least one stabilizer along the hollow bore and at least one of said first and second tapes urges either extension or retraction of the piston and displacement of the at least one stabilizer within the hollow bore upon either extension or retraction of the first and second tapes from the drive system.

14) In yet a further variant, the linear drive mechanism further includes a linear track. the track extends outwardly from the drive system. At least one truck is provided. The truck has a mounting feature, an aperture, an attachment point, an inner end and an outer end and is sized, shaped and located to move slidably along the linear track. The at least one truck has one of the at least one second tape guides attached so as to orient the truck orthogonally to the first and second tapes and to the linear track. A spacing segment is provided. The spacing segment has an outboard end and an inboard end and is attached at the outboard end to the attachment point of the at least one truck.

The spacing segment is sized, shaped and located to pass slidably through the aperture in another of the at least one truck and has a stopping portion at the inboard end. The stopping portion prevents the inboard end from passing through the aperture. An outermost truck is attached at the inner end to at least one of the second end of the first tape and to the distal end of the second tape. The first and second tapes extend from the drive system through the at least one second tape guide attached to the at least one truck along the linear track and at least one of said first and second tapes urges displacement of the at least one truck along the linear track upon either extension or retraction of the first and second tapes from the drive system. The mounting feature causing displacement of an item mounted thereto.

15) In another variant of the invention, at least one additional linear drive mechanism is provided. The additional drive mechanism is located adjacent the linear drive mechanism and has first and second tapes of the additional drive mechanism parallel to first and second tapes of the linear drive mechanism. An external tubing member is provided. The external tubing member has a first end and a second end. The second end is sized and shaped to enclose the linear drive mechanism and the at least one additional linear drive mechanism.

A series of nested internal tubing members is provided. Each of the internal members has a proximal end and a distal end. The proximal end of a largest of the internal tubing members is restricted from passing through the first end of the external tubing member. The proximal end of each succeeding smaller internal tubing member is restricted from passing through the distal end of an internal tubing member within which it is immediately nested. At least two of the second tape guides are centrally attached adjacent either the proximal end or the distal end.

An end cap is provided. The end cap is attached to either a proximal end or a distal end of a smallest of the internal tubing members and attaches to at least one of the first end of the first tape and the distal end of the second tape of the linear drive mechanism and attaches to the first end of the first tape and the distal end of the second tape of the at least one additional linear drive mechanism. At least one of the first and second tapes urges the end cap either toward or away from the drive systems as the first and second tapes are either extended or retracted. The end cap either extends or retracts the at least one internal tubing member from the external tubing member and the drive systems.

16) In still another variant, a first sleeve bearing is provided. The first sleeve bearing is located adjacent the first end of the external tubing member, is sized and shaped to fit slidably about the largest internal tubing member and has a first internal diameter. At least one base bearing is provided. The base bearing is located adjacent the proximal end of the internal tubing member, is sized and shaped to fit slidably within either of the external tubing member and a preceding, larger internal tubing member within which the internal tubing member is immediately nested. At least one second sleeve bearing is provided. The second sleeve bearing is located adjacent the distal end of the internal tubing member, is sized and shaped to fit slidably about a subsequent, smaller internal tubing member nested immediately within the internal tubing member and has an internal diameter.

The base bearing has an external diameter larger than either the first internal diameter or the internal diameter of the second sleeve bearing of the internal tubing member within which the subsequent, smaller internal tubing member to which the base bearing is attached is immediately nested. The first and second sleeve bearings and the base bearings prevent disassembly of the external tubing member and the series of nested internal tubing members during extension of the first and second tapes from the drive mechanism.

17) In yet another variant, one of the at least one second tape guides is centrally attached to the base bearing.

18) In still another variant of the invention, a first tape is provided. The first tape is formed of resilient material, has a first inner surface, a parallel first outer surface, a first length, a first near side edge, a first far side edge, a first end, a second end and a first concave/convex cross-section. A second tape is provided. The second tape is formed of resilient material, has a second inner surface, a parallel second outer surface, a second length, a second near side edge, a second far side edge, a proximal end, a distal end and a second concave/convex cross-section. A first tape guide is provided. The first tape guide has first and second guide slots. The first and second slots are sized and shaped to fit slidably about the first and second tapes and located to position the first outer surface adjacent the second outer surface. At least one second tape guide is provided. The second tape guide has third and fourth guide slots. The third and fourth slots are sized and shaped to fit slidably about the first and second tapes and located to position the first outer surface adjacent the second outer surface. The first tape is slidably connected adjacent the first end to the second tape adjacent the distal end.

A drive system is provided. The drive system has a mounting for the first tape guide. The mounting locates the first tape guide orthogonal to first and second lengths of the first and second tapes, respectively. The drive system has rolled storage for the first and second tapes and has driving members for extending and retracting the first and second tapes through the first and at least one second tape guide. The first and second tapes are directed through the first tape guide and the at least one second tape guides and are extended or retracted by the drive system.

19) In yet another variant the drive system further includes a drive base. The drive base provides a bearing surface for the linear drive mechanism. A tape reel is provided. The reel is mounted on a bearing in the drive base and provides the rolled storage for the first tape and the second tape. A drive roller assembly is provided. The drive roller assembly is located within the drive base adjacent the tape reel, has a first drive surface engaging the first inner surface and is driven in either a first or a second rotational direction by a drive motor.

An idler roller assembly is provided. The idler roller assembly is located within the drive base, has a second drive surface engaging the second inner surface and is movable toward and away from the second inner surface. The driving members include the drive roller assembly, idler roller assembly and the drive motor.

20) In a variant of the invention, an external tubing member is provided. The external member has a first end and a second end. The second end is sized and shaped to attach to the drive system. A series of nested internal tubing members is provided. Each of the internal members has a proximal end and a distal end. The proximal end of a largest of the internal tubing members is restricted from passing through the first end of the external tubing member. The proximal end of each succeeding smaller internal tubing member is restricted from passing through the distal end of an internal tubing member within which it is immediately nested. One of the at least one second tape guides is centrally attached adjacent either the proximal end or the distal end. An end cap is provided. The end cap is attached to either a proximal end or a distal end of a smallest of the internal tubing members and attaches to at least one of the first end of the first tape and the distal end of the second tape. At least one of the first and second tapes urges the end cap either toward or away from the drive system as the first and second tapes are either extended or retracted. The end cap either extends or retracts the at least one internal tubing member from the external tubing member and the drive system.

(21) In another variant, a first sleeve bearing is provided. The first sleeve bearing is located adjacent the first end of the external tubing member, is sized and shaped to fit slidably about the largest internal tubing member and has a first internal diameter. At least one base bearing is provided. The base bearing is located adjacent the proximal end of the internal tubing member, is sized and shaped to fit slidably within either of the external tubing member and a preceding, larger internal tubing member within which the internal tubing member is immediately nested. At least one second sleeve bearing is provided. The second sleeve bearing is located adjacent the distal end of the internal tubing member, is sized and shaped to fit slidably about a subsequent, smaller internal tubing member nested immediately within the internal tubing member and has an internal diameter.

The base bearing has an external diameter larger than either the first internal diameter or the internal diameter of the second sleeve bearing of the internal tubing member within which the subsequent, smaller internal tubing member to which the base bearing is attached is immediately nested. The first and second sleeve bearings and the base bearing prevent disassembly of the external tubing member and the series of nested internal tubing members during extension of the first and second tapes from the drive mechanism.

22) In still another variant, one of the at least one second tape guides is centrally attached to the base bearing.

23) In a further variant, the idler roller assembly further includes a roller support body. The support body has an axel upon which an idler roller is rotatably mounted. A compression spring is provided. The compression spring urges the support body toward the second inner surface. An adjusting screw threadedly engages either the support body or the drive base. The adjusting screw varies preloading of the compression spring.

24) In still a further variant, at least one tape support is provided. The support is attached to the drive base adjacent the reel and provides a bearing surface adjacent the first inner surface. The tape support prevents buckling of at least one of the first tape or the second tape under load.

25) In yet a further variant, the first and second drive surfaces are formed of resilient material selected from the group that includes rubber, silicone, plastic, leather and fabric.

26) In another variant of the invention, the first tape further includes a series of uniform sprocket holes adjacent at least one of the first near side edge and the first far side edge and the second tape further includes a mating series of uniform sprocket holes adjacent at least one of the second near side edge and the second far side edge.

27) In still another variant, the first drive surface further includes at least one series of uniform sprocket projections. The sprocket projections are sized, shaped and located to engage the sprocket holes in the first tape and the mating series of uniform sprocket holes in the second tape.

28) In yet another variant, the second drive surface is includes at least one of either a series of uniform sprocket detents or a receiving groove. The sprocket detents and the groove are sized, shaped and located to receive the at least one series of uniform sprocket projections.

29) In a further variant, the linear drive mechanism further includes at least one expandable bellows section. The bellows section is formed of resilient material and has a proximal end, a distal end and a central axis. At least one of the expandable bellows sections has one of the second tape guides attached at one of the proximal end and the distal end. The first and second tapes extend from the drive system through the at least one expandable bellows section along the central axis and at least one of said first and second tapes urge either expansion or contraction of the bellows section upon either extension or retraction of the first and second tapes from the drive system.

30) In still a further variant, the linear drive mechanism further includes a tubing section. The tubing section has a hollow bore, a proximal end, a distal end and is attached at the proximal end to the drive system. A piston is provided. The piston has an inner face and an outer face, is sized, shaped and located to fit sealably within the hollow bore and is attached at the inner face to at least one of the second end of the first tape and the distal end of the second tape. At least one stabilizer is provided. The stabilizer has an aperture and an attachment point and is sized, shaped and located to fit slidably within the hollow bore and has one of the at least one second tape guides attached so as to orient the stabilizer orthogonally to the first and second tapes and to the hollow bore.

A spacing member is provided. The spacing member has an outboard end and an inboard end and is attached at the outboard end to either of the inner face of the piston and the attachment point of the at least one stabilizer. The spacing member is sized, shaped and located to pass slidably through the aperture in another of the at least one stabilizer and has a stopping portion at the inboard end. The stopping portion prevents the inboard end from passing through the aperture. The first and second tapes extend from the drive system through the at least one stabilizer along the hollow bore and at least one of said first and second tapes urges either extension or retraction of the piston and displacement of the at least one stabilizer within the hollow bore upon either extension or retraction of the first and second tapes from the drive system.

31) In yet a further variant, the linear drive mechanism further includes a linear track. the track extends outwardly from the drive system. At least one truck is provided. The truck has a mounting feature, an aperture, an attachment point, an inner end and an outer end and is sized, shaped and located to move slidably along the linear track. The at least one truck has one of the at least one second tape guides attached so as to orient the truck orthogonally to the first and second tapes and to the linear track. A spacing segment is provided. The spacing segment has an outboard end and an inboard end and is attached at the outboard end to the attachment point of the at least one truck.

The spacing segment is sized, shaped and located to pass slidably through the aperture in another of the at least one truck and has a stopping portion at the inboard end. The stopping portion prevents the inboard end from passing through the aperture. An outermost truck is attached at the inner end to at least one of the second end of the first tape and to the distal end of the second tape. The first and second tapes extend from the drive system through the at least one second tape guide attached to the at least one truck along the linear track and at least one of said first and second tapes urges displacement of the at least one truck along the linear track upon either extension or retraction of the first and second tapes from the drive system. The mounting feature causing displacement of an item mounted thereto.

32) In another variant of the invention, at least one additional linear drive mechanism is provided. The additional drive mechanism is located adjacent the linear drive mechanism and has first and second tapes of the additional drive mechanism parallel to first and second tapes of the linear drive mechanism. An external tubing member is provided. The external tubing member has a first end and a second end. The second end is sized and shaped to enclose the linear drive mechanism and the at least one additional linear drive mechanism.

A series of nested internal tubing members is provided. Each of the internal members has a proximal end and a distal end. The proximal end of a largest of the internal tubing members is restricted from passing through the first end of the external tubing member. The proximal end of each succeeding smaller internal tubing member is restricted from passing through the distal end of an internal tubing member within which it is immediately nested. At least two of the second tape guides are centrally attached adjacent either the proximal end or the distal end.

An end cap is provided. The end cap is attached to either a proximal end or a distal end of a smallest of the internal tubing members and attaches to at least one of the first end of the first tape and the distal end of the second tape of the linear drive mechanism and attaches to the first end of the first tape and the distal end of the second tape of the at least one additional linear drive mechanism. At least one of the first and second tapes urges the end cap either toward or away from the drive systems as the first and second tapes are either extended or retracted. The end cap either extends or retracts the at least one internal tubing member from the external tubing member and the drive systems.

33) In still another variant, a first sleeve bearing is provided. The first sleeve bearing is located adjacent the first end of the external tubing member, is sized and shaped to fit slidably about the largest internal tubing member and has a first internal diameter. At least one base bearing is provided. The base bearing is located adjacent the proximal end of the internal tubing member, is sized and shaped to fit slidably within either of the external tubing member and a preceding, larger internal tubing member within which the internal tubing member is immediately nested. At least one second sleeve bearing is provided. The second sleeve bearing is located adjacent the distal end of the internal tubing member, is sized and shaped to fit slidably about a subsequent, smaller internal tubing member nested immediately within the internal tubing member and has an internal diameter.

The base bearing has an external diameter larger than either the first internal diameter or the internal diameter of the second sleeve bearing of the internal tubing member within which the subsequent, smaller internal tubing member to which the base bearing is attached is immediately nested. The first and second sleeve bearings and the base bearings prevent disassembly of the external tubing member and the series of nested internal tubing members during extension of the first and second tapes from the drive mechanism.

34) In a final variant, one of the at least one second tape guides is centrally attached to the base bearing.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of a first embodiment of the invention including a series of nested tubing members in a retracted state enclosing the first and second tapes;

FIG. 1A is a perspective view of the first and second tapes and the first and second tape guides of the FIG. 1 embodiment;

FIG. 1B is a cross-sectional view of the drive mechanism and the first and second tapes and the first and second tape guides of the FIG. 1 embodiment;

FIG. 2 is a perspective view of the FIG. 1 embodiment including a series of nested tubing members in an extended state;

FIG. 3 is a cross sectional side elevation of the FIG. 1 embodiment;

FIG. 4 is a perspective view of the first tape guide;

FIG. 4A is a perspective view of the second tape guide;

FIG. 5 is a perspective view of the lower end of the external tubing member and second tape guide of the FIG. 1 embodiment;

FIG. 6 is a partial perspective view of the drive base of the FIG. 1 embodiment illustrating the mounting for the first tape guide and the first and second tapes;

FIG. 7 is a side elevational view of a second embodiment of the invention including a series of collapsible bellows illustrated in a collapsed condition;

FIG. 8 is a side elevational view of the FIG. 7 embodiment illustrating the bellows in an expanded condition;

FIG. 9 is a side elevational view of a third embodiment of the invention including a piston fitted into a hollow bore illustrating the piston in a retracted position;

FIG. 10 is a side elevational view of the FIG. 9 embodiment illustrating the piston in an extended position;

FIG. 10A is a side elevational view of the spacing member of the FIG. 9 embodiment;

FIG. 10B is a side elevational view of the stabilizer of the FIG. 9 embodiment;

FIG. 11 is a side elevational view of a fourth embodiment of the invention including a support rail and a mechanism for positioning vertical blind elements;

FIG. 12 is a perspective view of a second embodiment of the driving members of the FIG. 1 embodiment illustrating a series of sprocket holes in the first tape, sprockets on the drive roller and sprocket detents in the idle roller;

FIG. 12A is a perspective view of a third embodiment of the driving members illustrating a series of sprocket holes in the first and second tapes, sprockets on the drive roller and a groove in the idle roller;

FIG. 13 is a partial perspective view of three drive systems of the FIG. 1B embodiment arranged within a large set of nested tubing members;

FIG. 14 is a partial perspective view of the first and second tapes illustrating the sliding connection between the tapes; and

FIG. 15 is a cross sectional side elevation of a second embodiment of the invention in which the first and second tapes are wound onto a single reel.

### DETAILED DESCRIPTION OF THE PREFERRED EMBODIMENT

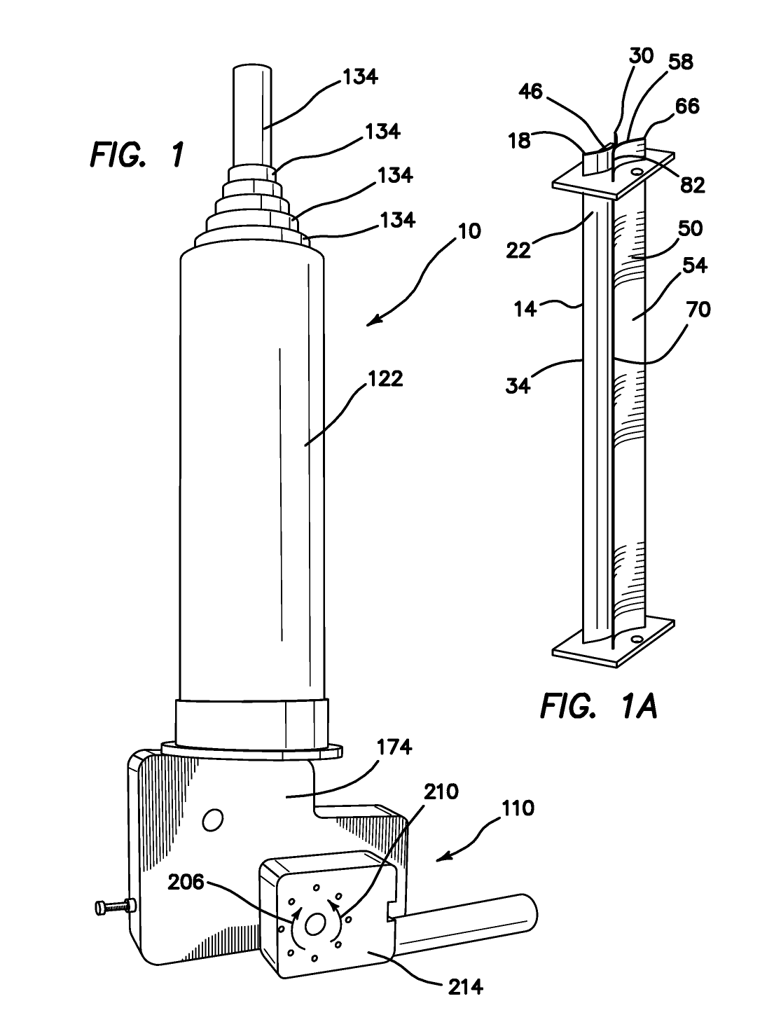

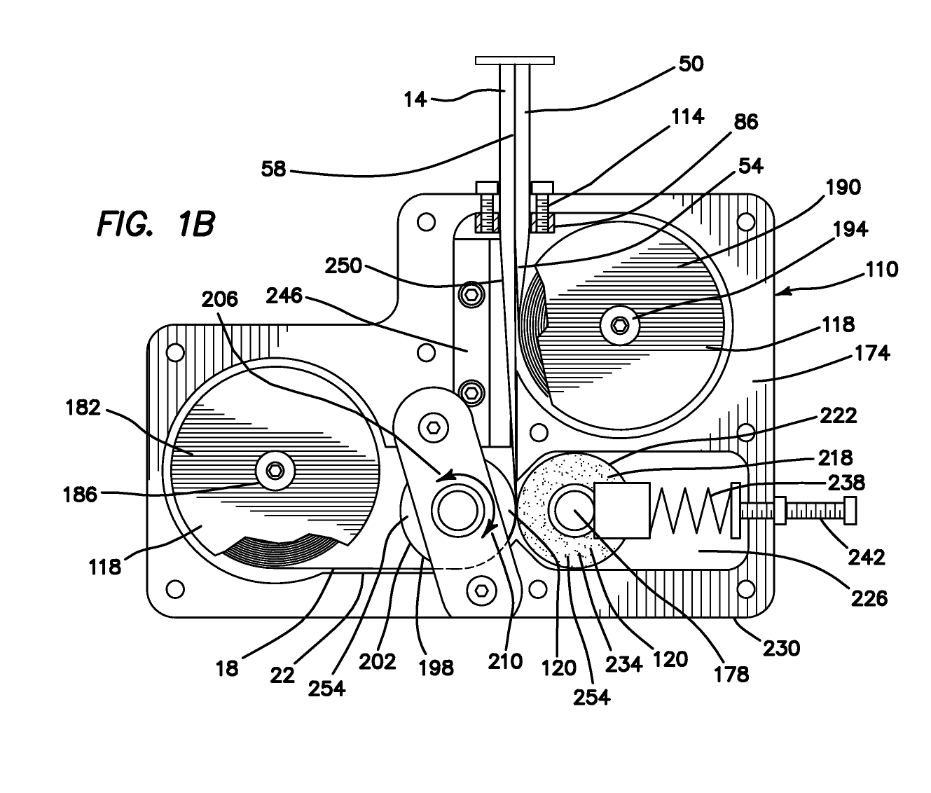

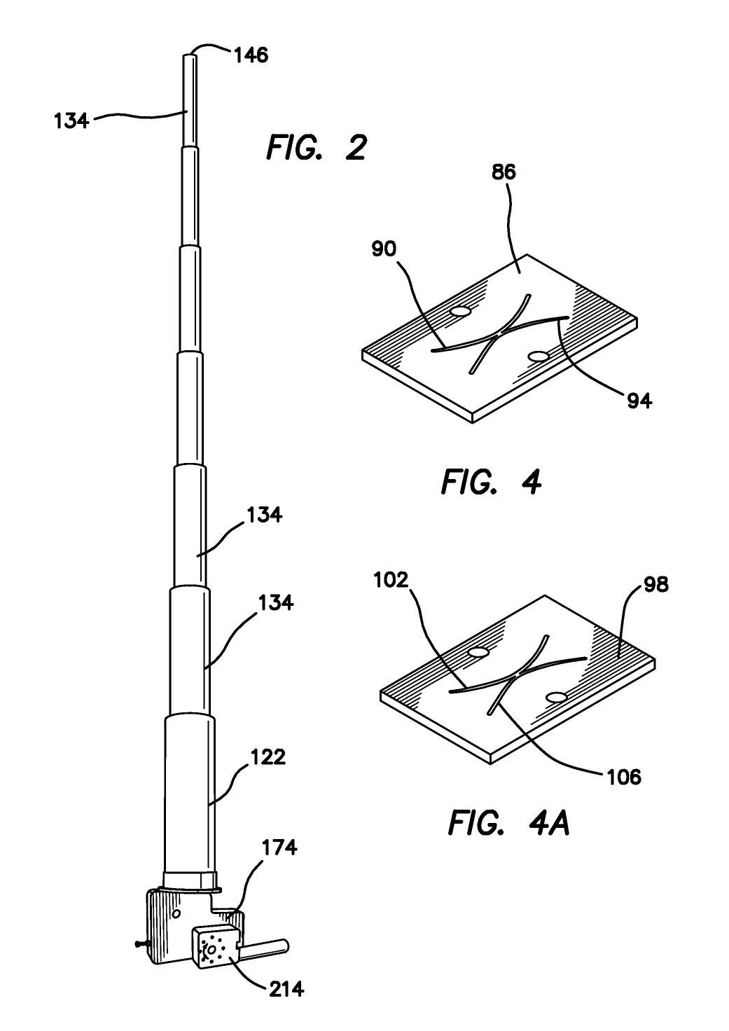

1) FIGS. 1-15 illustrate a linear drive mechanism 10 providing the desired features may be constructed from the following components. As illustrated in FIGS. 1-6, a first tape 14 is provided. The first tape 14 is formed of resilient material, has a first inner surface 18, a parallel first outer surface 22, a first length (not shown), a first near side edge 30, a first far side edge 34, a first end 38, a second end (not shown) and a first concave/convex cross-section 46. A second tape 50 is provided. The second tape 50 is formed of resilient material, has a second inner surface 54, a parallel second outer surface 58, a second length (not shown), a second near side edge 66, a second far side edge 70, a proximal end (not shown), a distal end 78 and a second concave/convex cross-section 82.

A first tape guide 86, as illustrated in FIG. 4, is provided. The first tape guide 86 has first 90 and second 94 guide slots. The first 90 and second 94 slots are sized and shaped to fit slidably about the first 14 and second 50 tapes and located to position the first outer surface 22 adjacent the second outer surface 58. At least one second tape guide 98, as illustrated in FIG. 4A, is provided. The second tape guide 98 has third 102 and fourth 106 guide slots. The third 102 and fourth 106 slots are sized and shaped to fit slidably about the first 14 and second 50 tapes and located to position the first outer surface 22 adjacent the second outer surface 58. The first tape 14 is connected adjacent the first end 38 to the second tape 50 adjacent the distal end 78.

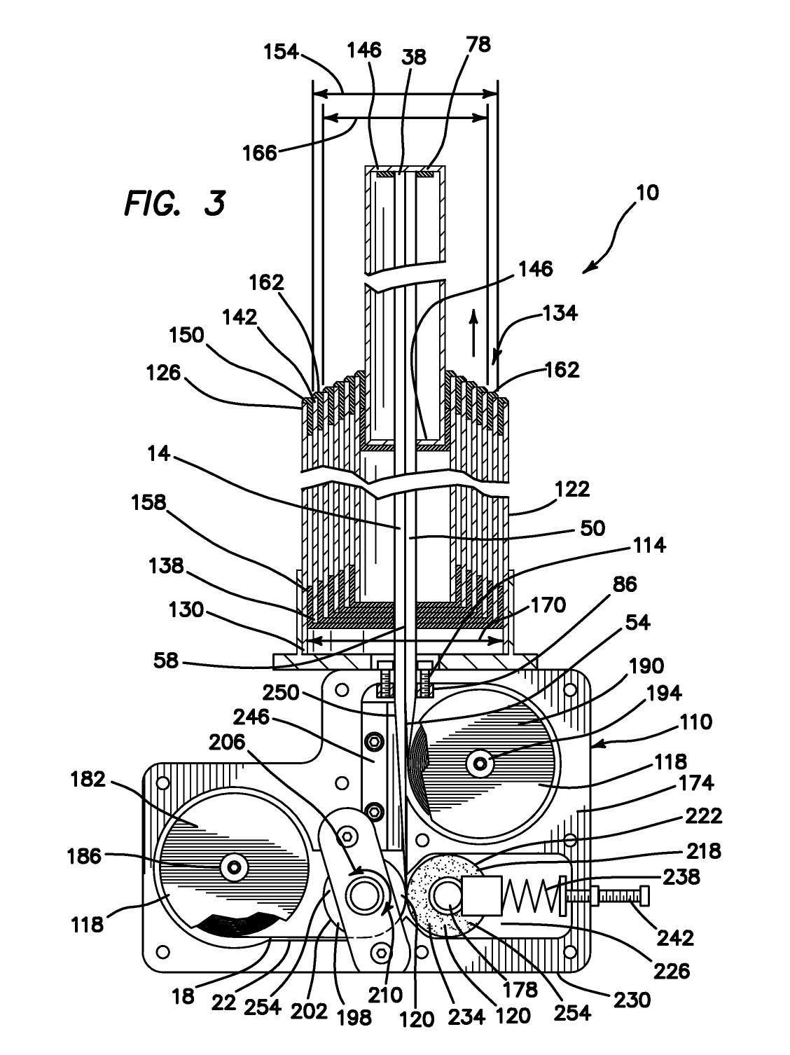

A drive system 110, as illustrated in FIGS. 1B and 3, is provided. The drive system 110 has a mounting 114 for the first tape guide 86. The mounting 114 locates the first tape guide 86 orthogonal to first and second lengths of the first 14 and second 50 tapes, respectively. The drive system 110 has rolled storage 118 for the first 14 and second 50 tapes and has driving members 120 for extending and retracting the first 14 and second 50 tapes through the first 86 and at least one second 98 tape guide. The first 14 and second 50 tapes are directed through the first tape guide 86 and the at least one second 98 tape guides and are extended or retracted by the drive system 110.

2) In a variant of the invention, as illustrated in FIGS. 1-3, an external tubing member 122 is provided. The external member 122 has a first end 126 and a second end 130. The second end 130 is sized and shaped to attach to the drive system 110. A series of nested internal tubing members 134 is provided. Each of the internal members 134 has a proximal end 138 and a distal end 142. The proximal end 138 of a largest of the internal tubing members 134 is restricted from passing through the first end 126 of the external tubing member 122. The proximal end 138 of each succeeding smaller internal tubing member 134 is restricted from passing through the distal end 142 of an internal tubing member within which it is immediately nested. One of the at least one second tape guides 98 is centrally attached adjacent either the proximal end 138 or the distal end 142. An end cap 146 is provided. The end cap 146 is attached to either a proximal end 138 or a distal end 142 of a smallest of the internal tubing members 134 and attaches to at least one of the first end 38 of the first tape 14 and the distal end 78 of the second tape 50. At least one of the first 14 and second 50 tapes urge the end cap 146 either toward or away from the drive system 110 as the first 14 and second 50 tapes are either extended or retracted. The end cap 146 either extends or retracts the at least one internal tubing member 134 from the external tubing member 122 and the drive system 110.

3) In another variant, as illustrated in FIGS. 1B and 3, a first sleeve bearing 150 is provided. The first sleeve bearing 150 is located adjacent the first end 126 of the external tubing member 122, is sized and shaped to fit slidably about the largest internal tubing member 134 and has a first internal diameter 154. At least one base bearing 158 is provided. The base bearing 158 is located adjacent the proximal end 138 of the internal tubing member 134, is sized and shaped to fit slidably within either of the external tubing member 122 and a preceding, larger internal tubing member 134 within which the internal tubing member 134 is immediately nested. At least one second sleeve bearing 162 is provided. The second sleeve bearing 162 is located adjacent the distal end 142 of the internal tubing member 134, is sized and shaped to fit slidably about a subsequent, smaller internal tubing member 134 nested immediately within the internal tubing member 134 and has an internal diameter 166.

The base bearing 158 has an external diameter 170 larger than either the first internal diameter 154 or the internal 166 diameter of the second sleeve bearing 162 of the internal tubing member 134 within which the subsequent, smaller internal tubing member 134 to which the base bearing 158 is attached is immediately nested. The first 150 and second 162 sleeve bearings and the base bearing 158 prevent disassembly of the external tubing member 122 and the series of nested internal tubing members 134 during extension of the first 14 and second 50 tapes from the drive mechanism 110.

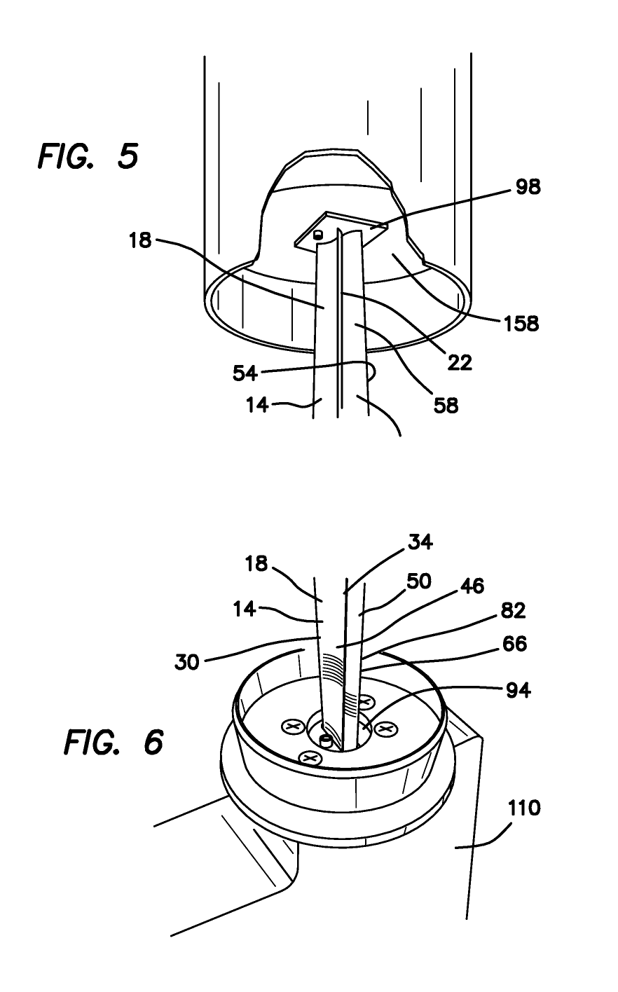

4) In still another variant, as illustrated in FIG. 5, one of the at least one second tape guides 98 is centrally attached to the base bearing 158.

5) In yet another variant, as illustrated in FIGS. 1, 1B, 2 and 3, the drive system 110 further includes a drive base 174. The drive base 174 provides a bearing surface 178 for the linear drive mechanism 10. A first tape reel 182 is provided. The first reel 182 is mounted on a first bearing 186 in the drive base 174 and provides the rolled storage 118 for the first tape 14. A second tape reel 190 is provided. The second reel 190 is mounted on a second bearing 194 in the drive base 174 and provides the rolled storage 118 for the second tape 50. A drive roller assembly 198 is provided. The drive roller assembly 198 is located within the drive base 174 adjacent the first tape reel 182, has a first drive surface 202 engaging the first inner surface 18 and is driven in either a first 206 or a second 210 rotational direction by a drive motor 214.

An idler roller assembly 218 is provided. The idler roller assembly 218 is located within the drive base 174, has a second drive surface 222 engaging the second inner surface 54 and is movable toward and away from the second inner surface 54. The driving members 120 include the drive roller assembly 198, idler roller assembly 218 and the drive motor 214.

6) In a further variant, the idler roller assembly 218 further includes a roller support body 226. The support body 226 has an axel 230 upon which an idler roller 234 is rotatably mounted. A compression spring 238 is provided. The compression spring 238 urges the support body 226 toward the second inner surface 54. An adjusting screw 242 threadedly engages either the support body 226 or the drive base 174. The adjusting screw 242 varies preloading of the compression spring 238.

7) In still a further variant, a first tape support 246 is provided. The first support 246 is attached to the drive base 174 adjacent the second reel 190 and provides a bearing surface 250 adjacent the first inner surface 18. The first tape support 246 prevents buckling of the first tape 14 under load.

8) In yet a further variant, the first 202 and second 222 drive surfaces are formed of resilient material 254 selected from the group that includes rubber, silicone, plastic, leather and fabric.

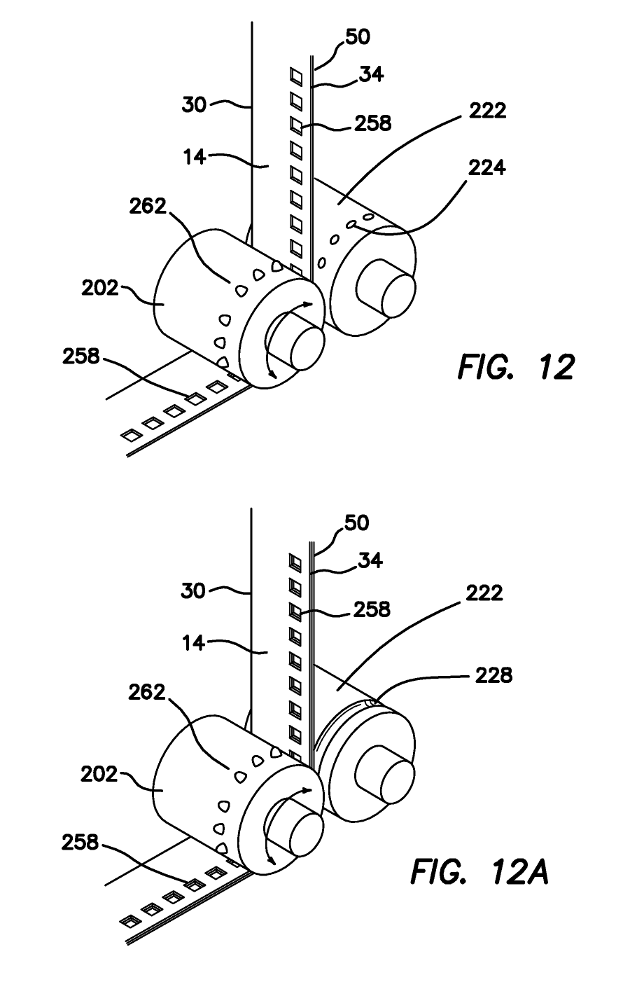

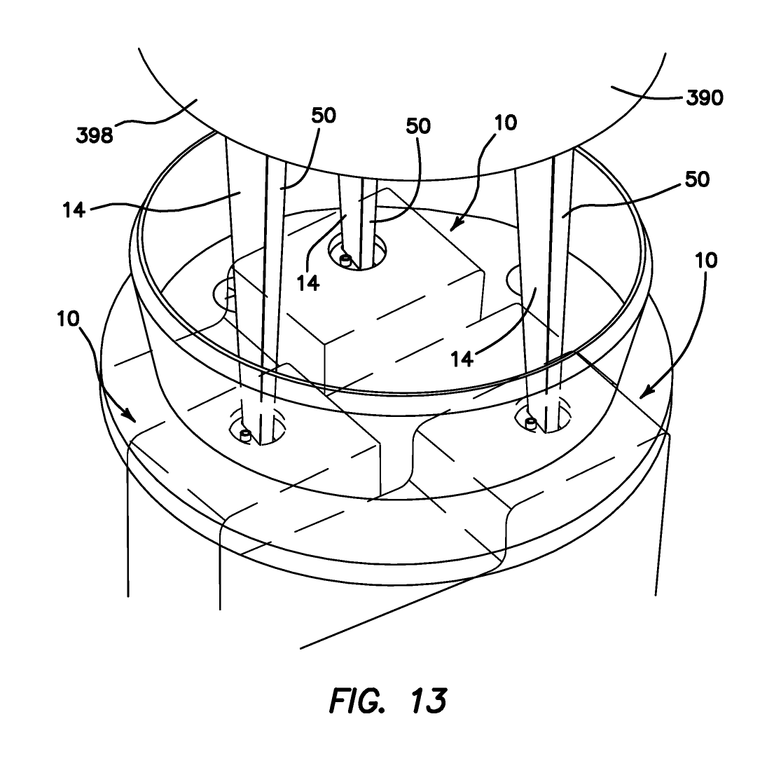

9) In another variant of the invention, as illustrated in FIG. 12, the first tape 14 further includes a series of uniform sprocket holes 258 adjacent at least one of the first near side edge 30 and the first far side edge 34.

10) In still another variant, the first drive surface 202 further includes at least one series of uniform sprocket projections 262. The sprocket projections 262 are sized, shaped and located to engage the sprocket holes 258 in the first tape 14.

11) In yet another variant, the second drive surface 222 includes at least one of either a series of uniform sprocket detents 224 or a receiving groove 228. The sprocket detents 224 and the groove 228 are sized, shaped and located to receive the at least one series of uniform sprocket projections 262.

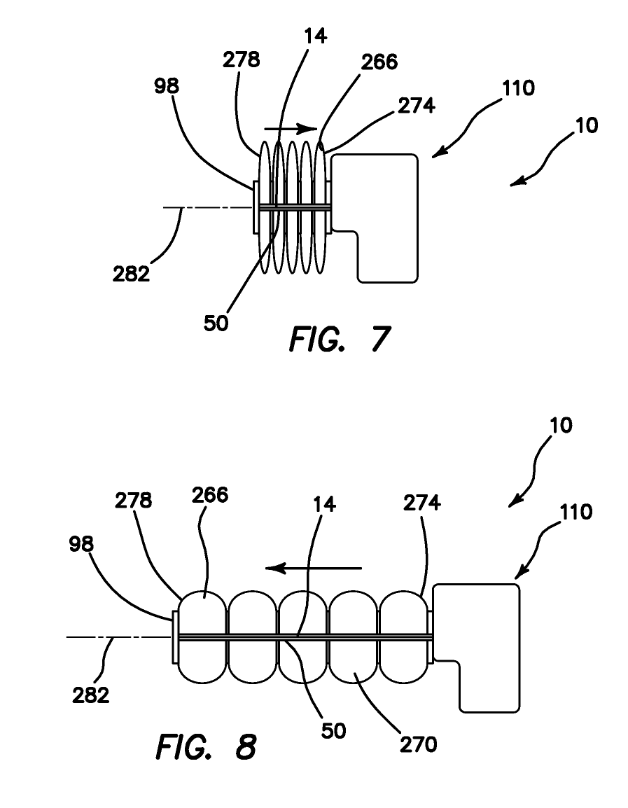

12) In a further variant, as illustrated in FIGS. 7 and 8, the linear drive mechanism 10 further includes at least one expandable bellows section 266. The bellows section 266 is formed of resilient material 270 and has a proximal end 274, a distal end 278 and a central axis 282. At least one of the expandable bellows sections 266 has one of the second tape guides 98 attached at one of the proximal end 274 and the distal end 278. The first 14 and second 50 tapes extend from the drive system 110 through the at least one expandable bellows 266 section along the central axis 282 and at least one of said first and second tapes urges either expansion or contraction of the bellows section 266 upon either extension or retraction of the first 14 and second 50 tapes from the drive system 110.

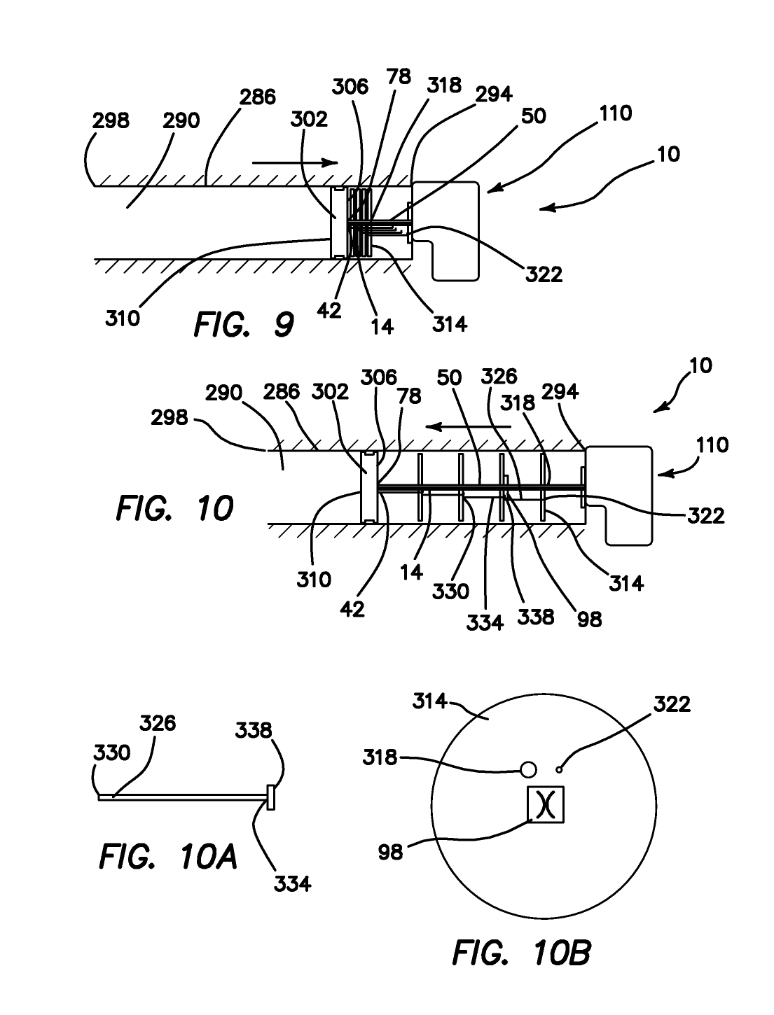

13) In still a further variant, as illustrated in FIGS. 9 and 10, the linear drive mechanism 10 further includes a tubing section 286. The tubing section 286 has a hollow bore 290, a proximal end 294, a distal end 298 and is attached at the proximal end 294 to the drive system 110. A piston 302 is provided. The piston 302 has an inner face 306 and an outer face 310, is sized, shaped and located to fit sealably within the hollow bore 290 and is attached at the inner face 306 to at least one of the second end 42 of the first tape 14 and the distal end 78 of the second tape 50. At least one stabilizer 314 is provided. The stabilizer 314 has an aperture 318 and an attachment point 322 and is sized, shaped and located to fit slidably within the hollow bore 290 and has one of the at least one second tape guides 98 attached so as to orient the stabilizer 314 orthogonally to the first 14 and second 50 tapes and to the hollow bore 290.

A spacing member 326 is provided. The spacing member 326 has an outboard end 330 and an inboard end 334 and is attached at the outboard end 330 to either of the inner face 306 of the piston 302 and the attachment point 322 of the at least one stabilizer 314. The spacing member 326 is sized, shaped and located to pass slidably through the aperture 318 in another of the at least one stabilizer 314 and has a stopping portion 338 at the inboard end 334. The stopping portion 338 prevents the inboard end 334 from passing through the aperture 318. The first 14 and second 50 tapes extend from the drive system 110 through the at least one stabilizer 314 along the hollow bore 290 and at least one of said first and second tapes urges either extension or retraction of the piston 302 and displacement of the at least one stabilizer 314 within the hollow bore 290 upon either extension or retraction of the first 14 and second 50 tapes from the drive system 110.

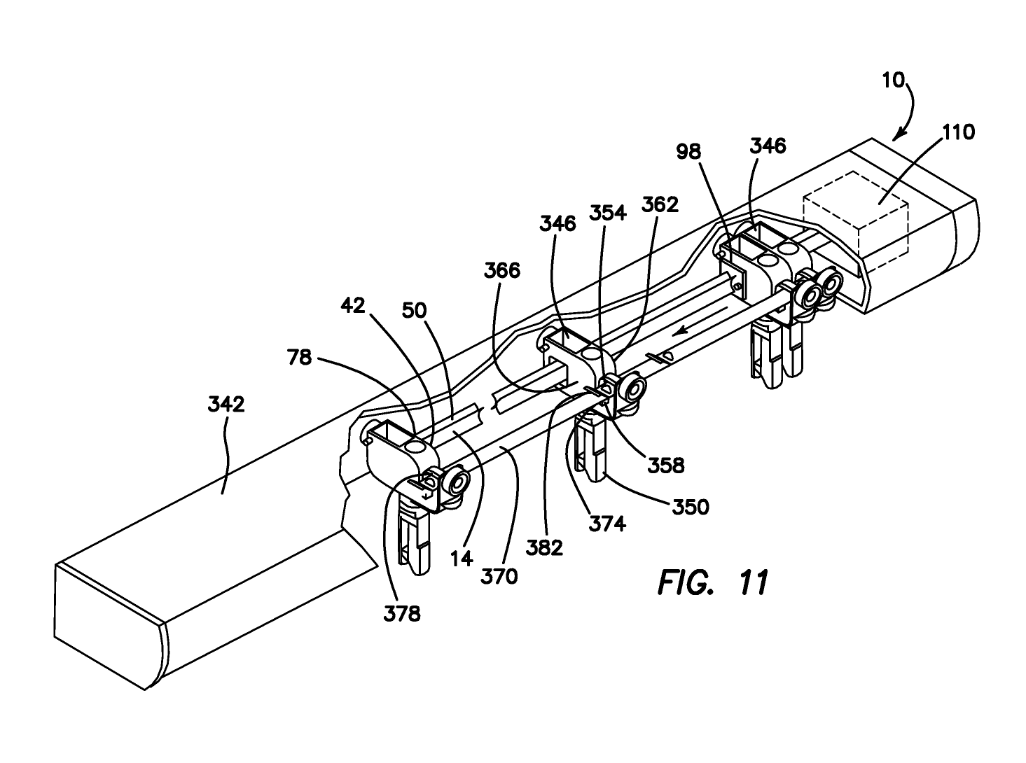

14) In yet a further variant, as illustrated in FIG. 11, the linear drive mechanism 10 further includes a linear track 342. The track 342 extends outwardly from the drive system 110. At least one truck 346 is provided. The truck 346 has a mounting feature 350, an aperture 354, an attachment point 358, an inner end 362 and an outer end 366 and is sized, shaped and located to move slidably along the linear track 342. The at least one truck 346 has one of the at least one second tape guides 98 attached so as to orient the truck 346 orthogonally to the first 14 and second 50 tapes and to the linear track 342. A spacing segment 370 is provided. The spacing segment 370 has an outboard end 374 and an inboard end 378 and is attached at the outboard end 374 to the attachment point 358 of the at least one truck 346.

The spacing segment 370 is sized, shaped and located to pass slidably through the aperture 354 in another of the at least one truck 346 and has a stopping portion 382 at the inboard end 378. The stopping portion 382 prevents the inboard end 378 from passing through the aperture 354. An outermost truck 346 is attached at the inner end 362 to at least one of the second end 42 of the first tape 14 and to the distal end 78 of the second tape 50. The first 14 and second 50 tapes extend from the drive system 110 through the at least one second tape guide 98 attached to the at least one truck 346 along the linear track 342 and at least one of said first and second tapes urges displacement of the at least one truck 346 along the linear track 342 upon either extension or retraction of the first 14 and second 50 tapes from the drive system 110. The mounting feature 350 causing displacement of an item (not shown) mounted thereto.

15) In another variant of the invention, as illustrated in FIG. 13, at least one additional linear drive mechanism 10 is provided. The additional drive mechanism 10 is located adjacent the linear drive mechanism 10 and has first 14 and second 50 tapes of the additional drive mechanism 10 parallel to first 14 and second 50 tapes of the linear drive mechanism 10. An external tubing member 390 is provided. The external tubing member 390 has a first end (not shown) and a second end 398. The second end 398 is sized and shaped to enclose the linear drive mechanism 10 and the at least one additional linear drive mechanism 10.

As illustrated in FIGS. 1-3 and 15, a series of nested internal tubing members 134 is provided. Each of the internal members 134 has a proximal end 138 and a distal end 142. The proximal end 138 of a largest of the internal tubing members 134 is restricted from passing through the first end (not shown) of the external tubing member 390. The proximal end 138 of each succeeding smaller internal tubing member 134 is restricted from passing through the distal end 142 of an internal tubing member within which it is immediately nested. At least two of the second tape guides 98 are centrally attached adjacent either the proximal end 138 or the distal end 142. An end cap 146 is provided. The end cap 146 is attached to either a proximal end 138 or a distal end 142 of a smallest of the internal tubing members 134 and attaches to at least one of the first end 38 of the first tape 14 and the distal end 78 of the second tape 50 and attaches to the first end 38 of the first tape 14 and the distal end 78 of the second tape 50 of the at least one additional linear drive mechanism 10. At least one of the first 14 and second 50 tapes urge the end cap 146 either toward or away from the drive systems 110 as the first 14 and second 50 tapes are either extended or retracted. The end cap 146 either extends or retracts the at least one internal tubing member 134 from the external tubing member 390 and the drive systems 110.

16) In still another variant, as illustrated in FIG. 3, a first sleeve bearing 150 is provided. The first sleeve bearing 150 is located adjacent the first end of the external tubing member 390, is sized and shaped to fit slidably about the largest internal tubing member 134 and has a first internal diameter 154. At least one base bearing 158 is provided. The base bearing 158 is located adjacent the proximal end 138 of the internal tubing member 134, is sized and shaped to fit slidably within either of the external tubing member 390 and a preceding, larger internal tubing member 134 within which the internal tubing member 134 is immediately nested. At least one second sleeve bearing 162 is provided. The second sleeve bearing 162 is located adjacent the distal end 142 of the internal tubing member 134, is sized and shaped to fit slidably about a subsequent, smaller internal tubing member 134 nested immediately within the internal tubing member 134 and has an internal diameter 166.

The base bearing 158 has an external diameter 170 larger than either the first internal diameter 154 or the internal 166 diameter of the second sleeve bearing 162 of the internal tubing member 134 within which the subsequent, smaller internal tubing member 134 to which the base bearing 158 is attached is immediately nested. The first 150 and second 162 sleeve bearings and the base bearings 158 prevent disassembly of the external tubing member 390 and the series of nested internal tubing members 134 during extension of the first 14 and second 50 tapes from the drive mechanism 110.

17) In yet another variant, as illustrated in FIG. 4A, one of the at least one second tape guides 98 is centrally attached to the base bearing 158.

18) In still another variant of the invention, as illustrated in FIGS. 1A, 12A and 15, a first tape 14 is provided. The first tape 14 is formed of resilient material, has a first inner surface 18, a parallel first outer surface 22, a first length (not shown), a first near side edge 30, a first far side edge 34, a first end 38, a second end (not shown) and a first concave/convex cross-section 46. A second tape 50 is provided. The second tape 50 is formed of resilient material, has a second inner surface 54, a parallel second outer surface 58, a second length (not shown), a second near side edge 66, a second far side edge 70, a proximal end (not shown), a distal end 78 and a second concave/convex cross-section 82.

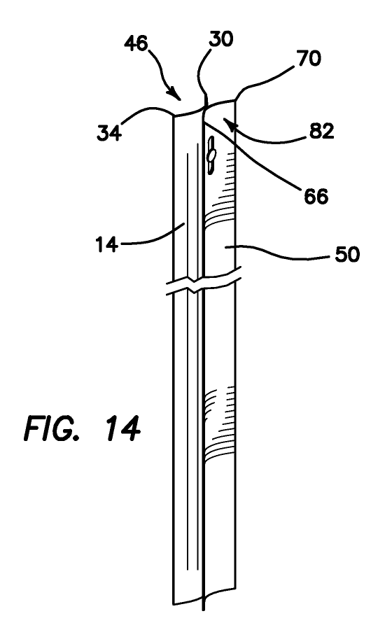

As illustrated in FIG. 4, a first tape guide 86 is provided. The first tape guide 86 has first 90 and second 94 guide slots. The first 90 and second 94 slots are sized and shaped to fit slidably about the first 14 and second 50 tapes and located to position the first outer surface 22 adjacent the second outer surface 58. As illustrated in FIG. 4A, at least one second tape guide 98 is provided. The second tape guide 98 has third 102 and fourth 106 guide slots. The third 102 and fourth 106 slots are sized and shaped to fit slidably about the first 14 and second 50 tapes and located to position the first outer surface 22 adjacent the second outer surface 58. As illustrated in FIG. 14, the first tape 14 is slidably connected adjacent the first end 38 to the second tape 50 adjacent the distal end 78.

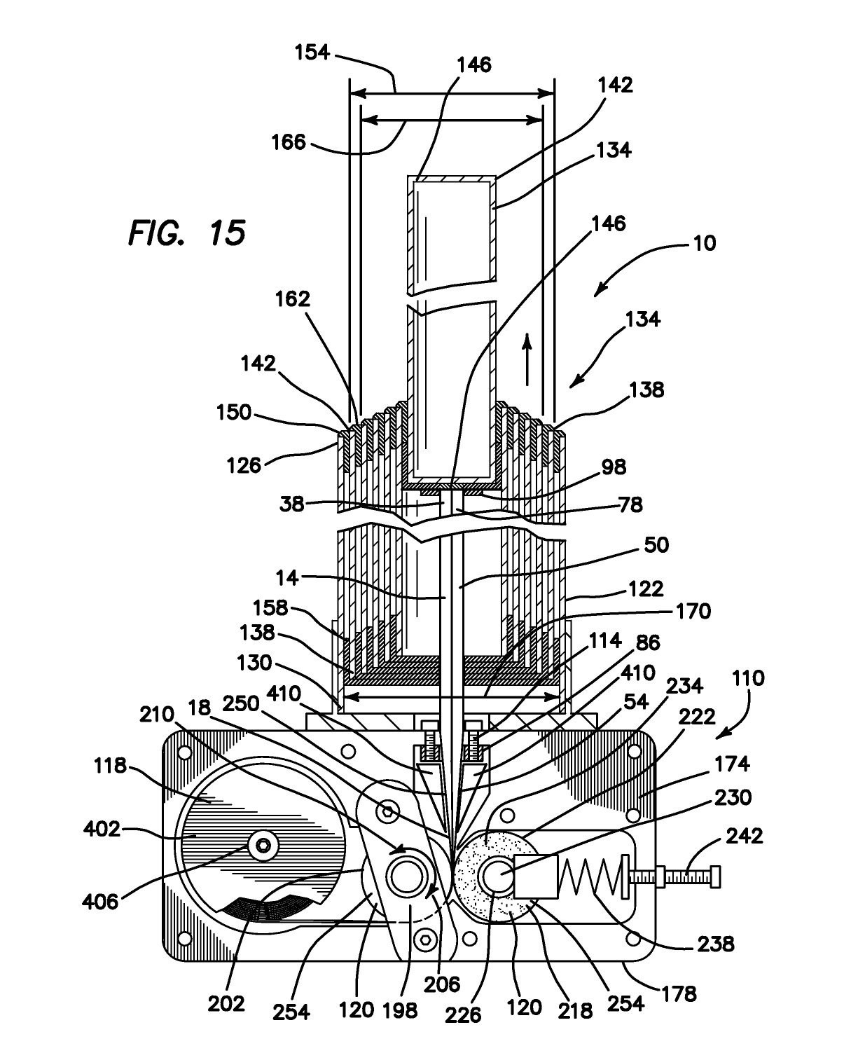

As illustrated in FIG. 15, drive system 110 is provided. The drive system 110 has a mounting 114 for the first tape guide 86. The mounting 114 locates the first tape guide 86 orthogonal to first and second lengths of the first 14 and second 50 tapes, respectively. The drive system 110 has rolled storage 118 for the first 14 and second 50 tapes and has driving members 120 for extending and retracting the first 14 and second 50 tapes through the first 86 and at least one second 98 tape guide. The first 14 and second 50 tapes are directed through the first tape guide 86 and the at least one second 98 tape guides and are extended or retracted by the drive system 110.

19) In yet another variant the drive system 110 further includes a drive base 174. The drive base 174 provides a bearing surface 178 for the linear drive mechanism 10. A tape reel 402 is provided. The reel 402 is mounted on a bearing 406 in the drive base 174 and provides the rolled storage 118 for the first tape 14 and the second tape 50. A drive roller assembly 198 is provided. The drive roller assembly 198 is located within the drive base 174 adjacent the tape reel 402, has a first drive surface 202 engaging the first inner surface 18 and is driven in either a first 206 or a second 210 rotational direction by a drive motor 214.

An idler roller assembly 218 is provided. The idler roller assembly 218 is located within the drive base 174, has a second drive surface 222 engaging the second inner surface 54 and is movable toward and away from the second inner surface 54. The driving members 120 include the drive roller assembly 198, idler roller assembly 218 and the drive motor 214.

20) In a variant of the invention, as illustrated in FIGS. 1, 2 and 15, an external tubing member 122 is provided. The external member 122 has a first end 126 and a second end 130. The second end 130 is sized and shaped to attach to the drive system 110. A series of nested internal tubing members 134 is provided. Each of the internal members 134 has a proximal end 138 and a distal end 142. The proximal end 138 of a largest of the internal tubing members 134 is restricted from passing through the first end 126 of the external tubing member 122. The proximal end 138 of each succeeding smaller internal tubing member 134 is restricted from passing through the distal end 142 of an internal tubing member within which it is immediately nested. One of the at least one second tape guides 98 is centrally attached adjacent either the proximal end 138 or the distal end 142. An end cap 146 is provided. The end cap 146 is attached to either a proximal end 138 or a distal end 142 of a smallest of the internal tubing members 134 and attaches to at least one of the first end 38 of the first tape 14 and the distal end 78 of the second tape 50. At least one of the first 14 and second 50 tapes urge the end cap 146 either toward or away from the drive system 110 as the first 14 and second 50 tapes are either extended or retracted. The end cap 146 either extends or retracts the at least one internal tubing member 134 from the external tubing member 122 and the drive system 110.

(21) In another variant, as illustrated in FIG. 15, a first sleeve bearing 150 is provided. The first sleeve bearing 150 is located adjacent the first end 126 of the external tubing member 122, is sized and shaped to fit slidably about the largest internal tubing member 134 and has a first internal diameter 154. At least one base bearing 158 is provided. The base bearing 158 is located adjacent the proximal end 138 of the internal tubing member 134, is sized and shaped to fit slidably within either of the external tubing member 122 and a preceding, larger internal tubing member 134 within which the internal tubing member 134 is immediately nested. At least one second sleeve bearing 162 is provided. The second sleeve bearing 162 is located adjacent the distal end 142 of the internal tubing member 134, is sized and shaped to fit slidably about a subsequent, smaller internal tubing member 134 nested immediately within the internal tubing member 134 and has an internal diameter 166.

The base bearing 158 has an external diameter 170 larger than either the first internal diameter 154 or the internal 166 diameter of the second sleeve bearing 162 of the internal tubing member 134 within which the subsequent, smaller internal tubing member 134 to which the base bearing 158 is attached is immediately nested. The first 150 and second 162 sleeve bearings and the base bearing 158 prevent disassembly of the external tubing member 122 and the series of nested internal tubing members 134 during extension of the first 14 and second 50 tapes from the drive mechanism 110.

22) In still another variant, as illustrated in FIG. 5, one of the at least one second tape guides 98 is centrally attached to the base bearing 158.

23) In a further variant, as illustrated in FIG. 15, the idler roller assembly 218 further includes a roller support body 226. The support body 226 has an axel 230 upon which an idler roller 234 is rotatably mounted. A compression spring 238 is provided. The compression spring 238 urges the support body 226 toward the second inner surface 54. An adjusting screw 242 threadedly engages either the support body 226 or the drive base 174. The adjusting screw 242 varies preloading of the compression spring 238.

24) In still a further variant, at least one tape support 410 is provided. The support 410 is attached to the drive base 174 adjacent the reel 402 and provides a bearing surface 250 adjacent the first inner surface 18. The tape support 410 prevents buckling of at least one of the first tape 14 or the second tape 50 under load.

25) In yet a further variant, the first 202 and second 222 drive surfaces are formed of resilient material 254 selected from the group that includes rubber, silicone, plastic, leather and fabric.

26) In another variant of the invention, as illustrated in FIG. 12A, the first tape 14 further includes a series of uniform sprocket holes 258 adjacent at least one of the first near side edge 30 and the first far side edge 34 and the second tape 50 further includes a mating series of uniform sprocket holes 258 adjacent at least one of the second near side edge 66 and the second far side edge 70.

27) In still another variant, the first drive surface 202 further includes at least one series of uniform sprocket projections 262. The sprocket projections 262 are sized, shaped and located to engage the sprocket holes 258 in the first tape 14 and said mating series of uniform sprocket holes 258 in said second tape 50.

28) In yet another variant, the second drive surface 222 includes at least one of either a series of uniform sprocket detents 224 or a receiving groove 228. The sprocket detents 224 and the groove 228 are sized, shaped and located to receive the at least one series of uniform sprocket projections 262.

29) In a further variant, as illustrated in FIGS. 7 and 8, the linear drive mechanism 10 further includes at least one expandable bellows section 266. The bellows section 266 is formed of resilient material 270 and has a proximal end 274, a distal end 278 and a central axis 282. At least one of the expandable bellows sections 266 has one of the second tape guides 98 attached at one of the proximal end 274 and the distal end 278. The first 14 and second 50 tapes extend from the drive system 110 through the at least one expandable bellows 266 section along the central axis 282 and at least one of said first and second tapes urges either expansion or contraction of the bellows section 266 upon either extension or retraction of the first 14 and second 50 tapes from the drive system 110.

30) In still a further variant, as illustrated in FIGS. 9 and 10, the linear drive mechanism 10 further includes a tubing section 286. The tubing section 286 has a hollow bore 290, a proximal end 294, a distal end 298 and is attached at the proximal end 294 to the drive system 110. A piston 302 is provided. The piston 302 has an inner face 306 and an outer face 310, is sized, shaped and located to fit sealably within the hollow bore 290 and is attached at the inner face 306 to at least one of the second end 42 of the first tape 14 and the distal end 78 of the second tape 50. At least one stabilizer 314 is provided. The stabilizer 314 has an aperture 318 and an attachment point 322 and is sized, shaped and located to fit slidably within the hollow bore 290 and has one of the at least one second tape guides 98 attached so as to orient the stabilizer 314 orthogonally to the first 14 and second 50 tapes and to the hollow bore 290.

A spacing member 326 is provided. The spacing member 326 has an outboard end 330 and an inboard end 334 and is attached at the outboard end 330 to either of the inner face 306 of the piston 302 and the attachment point 322 of the at least one stabilizer 314. The spacing member 326 is sized, shaped and located to pass slidably through the aperture 318 in another of the at least one stabilizer 314 and has a stopping portion 338 at the inboard end 334. The stopping portion 338 prevents the inboard end 334 from passing through the aperture 318. The first 14 and second 50 tapes extend from the drive system 110 through the at least one stabilizer 314 along the hollow bore 290 and at least one of said first and second tapes urges either extension or retraction of the piston 302 and displacement of the at least one stabilizer 314 within the hollow bore 290 upon either extension or retraction of the first 14 and second 50 tapes from the drive system 110.

31) In yet a further variant, as illustrated in FIG. 11, the linear drive mechanism 10 further includes a linear track 342. The track 342 extends outwardly from the drive system 110. At least one truck 346 is provided. The truck 346 has a mounting feature 350, an aperture 354, an attachment point 358, an inner end 362 and an outer end 366 and is sized, shaped and located to move slidably along the linear track 342. The at least one truck 346 has one of the at least one second tape guides 98 attached so as to orient the truck 346 orthogonally to the first 14 and second 50 tapes and to the linear track 342. A spacing segment 370 is provided. The spacing segment 370 has an outboard end 374 and an inboard end 378 and is attached at the outboard end 374 to the attachment point 358 of the at least one truck 346.

The spacing segment 370 is sized, shaped and located to pass slidably through the aperture 354 in another of the at least one truck 346 and has a stopping portion 382 at the inboard end 378. The stopping portion 382 prevents the inboard end 378 from passing through the aperture 354. An outermost truck 346 is attached at the inner end 362 to at least one of the second end 42 of the first tape 14 and to the distal end 78 of the second tape 50. The first 14 and second 50 tapes extend from the drive system 110 through the at least one second tape guide 98 attached to the at least one truck 346 along the linear track 342 and at least one of said first and second tapes urges displacement of the at least one truck 346 along the linear track 342 upon either extension or retraction of the first 14 and second 50 tapes from the drive system 110. The mounting feature 350 causing displacement of an item (not show) mounted thereto.

32) In another variant of the invention, as illustrated in FIG. 13, at least one additional linear drive mechanism 10 is provided. As illustrated in FIGS. 3 and 15, the additional drive mechanism 10 is located adjacent the linear drive mechanism 10 and has first 14 and second 50 tapes of the additional drive mechanism 10 parallel to first 14 and second 50 tapes of the linear drive mechanism 10. An external tubing member 390 is provided. The external tubing member 390 has a first end (not shown) and a second end 398. The second end 398 is sized and shaped to enclose the linear drive mechanism 10 and the at least one additional linear drive mechanism 10.

A series of nested internal tubing members 134 is provided. Each of the internal members 134 has a proximal end 138 and a distal end 142. The proximal end 138 of a largest of the internal tubing members 134 is restricted from passing through the first end of the external tubing member 390. The proximal end 138 of each succeeding smaller internal tubing member 134 is restricted from passing through the distal end 142 of an internal tubing member within which it is immediately nested. At least two of the second tape guides 98 are centrally attached adjacent either the proximal end 138 or the distal end 142. An end cap 146 is provided. The end cap 146 is attached to either a proximal end 138 or a distal end 142 of a smallest of the internal tubing members 134 and attaches to at least one of the first end 38 of the first tape 14 and the distal end 78 of the second tape 50 and attaches to the first end 38 of the first tape 14 and the distal end 78 of the second tape 50 of the at least one additional linear drive mechanism 10. At least one of the first 14 and second 50 tapes urges the end cap 146 either toward or away from the drive systems 110 as the first 14 and second 50 tapes are either extended or retracted. The end cap 146 either extends or retracts the at least one internal tubing member 134 from the external tubing member 390 and the drive systems 110.

33) In still another variant, as illustrated in FIG. 15, a first sleeve bearing 150 is provided. The first sleeve bearing 150 is located adjacent the first end of the external tubing member 390, is sized and shaped to fit slidably about the largest internal tubing member 134 and has a first internal diameter 154. At least one base bearing 158 is provided. The base bearing 158 is located adjacent the proximal end 138 of the internal tubing member 134, is sized and shaped to fit slidably within either of the external tubing member 390 and a preceding, larger internal tubing member 134 within which the internal tubing member 134 is immediately nested. At least one second sleeve bearing 162 is provided. The second sleeve bearing 162 is located adjacent the distal end 142 of the internal tubing member 134, is sized and shaped to fit slidably about a subsequent, smaller internal tubing member 134 nested immediately within the internal tubing member 134 and has an internal diameter 166.

The base bearing 158 has an external diameter 170 larger than either the first internal diameter 154 or the internal 166 diameter of the second sleeve bearing 162 of the internal tubing member 134 within which the subsequent, smaller internal tubing member 134 to which the base bearing 158 is attached is immediately nested. The first 150 and second 162 sleeve bearings and the base bearing 158 prevent disassembly of the external tubing member 390 and the series of nested internal tubing members 134 during extension of the first 14 and second 50 tapes from the drive mechanism 110.

34) In a final variant, as illustrated in FIG. 5, one of the at least one second tape guides 98 is centrally attached to the base bearing 158.

The linear drive mechanism 10 has been described with reference to particular embodiments. Other modifications and enhancements can be made without departing from the spirit and scope of the claims that follow.

1. A linear drive mechanism, comprising:
a first tape, said first tape being formed of resilient material, having a first inner surface, a parallel first outer surface, a first length, a first near side edge, a first far side edge, a first end, a second end and a first concave/convex cross-section;
a second tape, said second tape being formed of resilient material, having a second inner surface, a parallel second outer surface, a second length, a second near side edge, a second far side edge, a proximal end, a distal end and a second concave/convex cross-section;
a first tape guide, said first tape guide having first and second guide slots, said first and second slots being sized and shaped to fit slidably about said first and second tapes and disposed to position said first outer surface adjacent said second outer surface;
at least one second tape guide, said second tape guide having third and fourth guide slots, said third and fourth slots being sized and shaped to fit slidably about said first and second tapes and disposed to position said first outer surface adjacent said second outer surface;
said first tape connected adjacent said first end to said second tape adjacent said distal end;
a drive system, said drive system having a mounting for said first tape guide, said mounting disposing said first tape guide orthogonal to first and second lengths of said first and second tapes, respectively, having rolled storage for said first and second tapes and having driving members for extending and retracting said first and second tapes through said first and at least one second tape guide; and
said first and second tapes being directed through said first tape guide and said at least one second tape guides and being either of extended and retracted by said drive system.

2. The linear drive mechanism, as described in claim 1, further comprising:
an external tubing member, said external member having a first end and a second end, said second end being sized and shaped to attach to said drive system;
a series of nested internal tubing members, each of said internal members having a proximal end and a distal end;
said proximal end of a largest of said internal tubing members being restricted from passing through said first end of said external tubing member;
said proximal end of each succeeding smaller internal tubing member being restricted from passing through said distal end of an internal tubing member within which it is immediately nested;
one of said at least one second tape guides being centrally attached adjacent either of said proximal end and said distal end;
an end cap, said end cap attached to either of a proximal end and a distal end of a smallest of said internal tubing members and attaching to at least one of said first end of said first tape and said distal end of said second tape; and
at least one of said first and second tapes urging said end cap either of toward and away from said drive system as said first and second tapes are either of extended and retracted, said end cap either of extending or retracting said at least one internal tubing member from said external tubing member and said drive system.

3. The linear drive mechanism, as described in claim 2, further comprising:
a first sleeve bearing, said first sleeve bearing being disposed adjacent said first end of said external tubing member, being sized and shaped to fit slidably about said largest internal tubing member and having a first internal diameter;
at least one base bearing, said base bearing being disposed adjacent said proximal end of said internal tubing member, being sized and shaped to fit slidably within either of said external tubing member and a preceding, larger internal tubing member within which said internal tubing member is immediately nested;
at least one second sleeve bearing, said second sleeve bearing being disposed adjacent said distal end of said internal tubing member, being sized and shaped to fit slidably about a subsequent, smaller internal tubing member nested immediately within said internal tubing member and having an internal diameter;
said base bearing having an external diameter larger than either of said first internal diameter and said internal diameter of said second sleeve bearing of said internal tubing member within which said subsequent, smaller internal tubing member to which said base bearing is attached is immediately nested; and
said first and second sleeve bearings and said base bearings preventing disassembly of said external tubing member and said series of nested internal tubing members during extension of said first and second tapes from said drive mechanism.

4. The linear drive mechanism, as described in claim 3, wherein one of said at least one second tape guides is centrally attached to said base bearing.

5. The telescopic drive mechanism, as described in claim 1, wherein said drive system further comprises:
a drive base, said drive base providing a bearing surface for said linear drive mechanism;
a first tape reel, said first reel being mounted on a first bearing in said drive base and providing said rolled storage for said first tape;
a second tape reel, said second reel being mounted on a second bearing in said drive base and providing said rolled storage for said second tape;
a drive roller assembly, said drive roller assembly being disposed within said drive base adjacent said first tape reel, having a first drive surface engaging said first inner surface and being driven in either of a first and a second rotational direction by a drive motor;
an idler roller assembly, said idler roller assembly being disposed within said drive base, having a second drive surface engaging said second inner surface and being movable toward and away from said second inner surface; and
said drive roller assembly, idler roller assembly and said drive motor comprising said driving members.

6. The linear drive mechanism, as described in claim 5, wherein said idler roller assembly further comprises:
a roller support body, said support body having an axel upon which an idler roller is rotatably mounted;
a compression spring, said compression spring urging said support body toward said second inner surface; and
an adjusting screw threadedly engaging either of said support body and said drive base, said adjusting screw varying preloading of said compression spring.

7. The linear drive mechanism, as described in claim 5, further comprising:
a first tape support, said first support being attached to said drive base adjacent said second reel and providing a bearing surface adjacent said first inner surface; and
said first tape support preventing buckling of said first tape under load.

8. The linear drive mechanism, as described in claim 5, wherein said first and second drive surfaces are formed of resilient material selected from the group comprising:
rubber, silicone, plastic, leather and fabric.

9. The linear drive mechanism, as described in claim 5, wherein said first tape further comprises a series of uniform sprocket holes adjacent at least one of said first near side edge and said first far side edge.

10. The linear drive mechanism, as described in claim 9, wherein said first drive surface further comprises at least one series of uniform sprocket projections, said sprocket projections being sized, shaped and disposed to engage said sprocket holes in said first tape.

11. The linear drive mechanism, as described in claim 10, wherein said second drive surface comprises at least one of either of a series of uniform sprocket detents and a receiving groove, said sprocket detents and said groove being sized, shaped and disposed to receive said at least one series of uniform sprocket projections.

12. The linear drive mechanism, as described in claim 1, further comprising:
at least one expandable bellows section, said bellows section being formed of resilient material and having a proximal end, a distal end and a central axis;
at least one of said expandable bellows sections having one of said second tape guides attached at one of said proximal end and said distal end; and
said first and second tapes extending from said drive system through said at least one expandable bellows section along said central axis and at least one of said first and second tapes urging either of expansion and contraction of said bellows section upon either of extension and retraction of said first and second tapes from said drive system.

13. The linear drive mechanism, as described in claim 1, further comprising:
a tubing section, said tubing section having a hollow bore, a proximal end, a distal end and being attached at said proximal end to said drive system;
a piston, said piston having an inner face and an outer face, being sized, shaped and disposed to fit sealably within said hollow bore and being attached at said inner face to at least one of said second end of said first tape and said distal end of said second tape;
at least one stabilizer, said stabilizer having an aperture and an attachment point and being sized, shaped and disposed to fit slidably within said hollow bore and having one of said at least one second tape guides attached so as to orient said stabilizer orthogonally to said first and second tapes and to said hollow bore;
a spacing member, said spacing member having an outboard end and an inboard end and being attached at said outboard end to either of said inner face of said piston and said attachment point of said at least one stabilizer;
said spacing member being sized, shaped and disposed to pass slidably through said aperture in another of said at least one stabilizer and having a stopping portion at said inboard end, said stopping portion preventing said inboard end from passing through said aperture;
said first and second tapes extending from said drive system through said at least one stabilizer along said hollow bore and at least one of said first and second tapes urging either of extension and retraction of said piston and displacement of said at least one stabilizer within said hollow bore upon either of extension and retraction of said first and second tapes from said drive system.

14. The linear drive mechanism, as described in claim 1, further comprising:
a linear track, said track extending outwardly from said drive system;
at least one truck, said truck having a mounting feature, an aperture, an attachment point, an inner end and an outer end and being sized, shaped and disposed to move slidably along said linear track;
said at least one truck having one of said at least one second tape guides attached so as to orient said truck orthogonally to said first and second tapes and to said linear track;
a spacing segment, said spacing segment having an outboard end and an inboard end and being attached at said outboard end to said attachment point of said at least one truck;
said spacing segment being sized, shaped and disposed to pass slidably through said aperture in another of said at least one truck and having a stopping portion at said inboard end, said stopping portion preventing said inboard end from passing through said aperture;
an outermost truck being attached at said inner end to at least one of said second end of said first tape and to said distal end of said second tape;
said first and second tapes extending from said drive system through said at least one second tape guide attached to said at least one truck along said linear track and at least one of said first and second tapes urging displacement of said at least one truck along said linear track upon either of extension and retraction of said first and second tapes from said drive system, said mounting feature causing displacement of an item mounted thereto.

15. The linear drive mechanism, as described in claim 1, further comprising:
at least one additional linear drive mechanism; said additional drive mechanism being disposed adjacent said linear drive mechanism and having first and second tapes of said additional drive mechanism parallel to first and second tapes of said linear drive mechanism;
an external tubing member, said external member having a first end and a second end, said second end being sized and shaped to enclose said linear drive mechanism and said at least one additional linear drive mechanism;
a series of nested internal tubing members, each of said internal members having a proximal end and a distal end;
said proximal end of a largest of said internal tubing members being restricted from passing through said first end of said external tubing member;
said proximal end of each succeeding smaller internal tubing member being restricted from passing through said distal end of an internal tubing member within which it is immediately nested;
at least two of said second tape guides being centrally attached adjacent either of said proximal end and said distal end;
an end cap, said end cap attached to either of a proximal end and a distal end of a smallest of said internal tubing members and attaching to at least one of said first end of said first tape and said distal end of said second tape of said linear drive mechanism and attaching to said first end of said first tape and said distal end of said second tape of said at least one additional linear drive mechanism; and
at least one of said first and second tapes urging said end cap either of toward and away from said drive systems as said first and second tapes are either of extended and retracted, said end cap either of extending or retracting said at least one internal tubing member from said external tubing member and said drive systems.

16. The linear drive mechanism, as described in claim 15, further comprising:
a first sleeve bearing, said first sleeve bearing being disposed adjacent said first end of said external tubing member, being sized and shaped to fit slidably about said largest internal tubing member and having a first internal diameter;
at least one base bearing, said base bearing being disposed adjacent said proximal end of said internal tubing member, being sized and shaped to fit slidably within either of said external tubing member and a preceding, larger internal tubing member within which said internal tubing member is immediately nested;
at least one second sleeve bearing, said second sleeve bearing being disposed adjacent said distal end of said internal tubing member, being sized and shaped to fit slidably about a subsequent, smaller internal tubing member nested immediately within said internal tubing member and having an internal diameter;
said base bearing having an external diameter larger than either of said first internal diameter and said internal diameter of said second sleeve bearing of said internal tubing member within which said subsequent, smaller internal tubing member to which said base bearing is attached is immediately nested; and
said first and second sleeve bearings and said base bearings preventing disassembly of said external tubing member and said series of nested internal tubing members during extension of said first and second tapes from said drive mechanism.

17. The linear drive mechanism, as described in claim 16, wherein one of said at least one second tape guides is centrally attached to said base bearing.

18. A linear drive mechanism, comprising:
a first tape, said first tape being formed of resilient material, having a first inner surface, a parallel first outer surface, a first length, a first near side edge, a first far side edge, a first end, a second end and a first concave/convex cross-section;
a second tape, said second tape being formed of resilient material, having a second inner surface, a parallel second outer surface, a second length, a second near side edge, a second far side edge, a proximal end, a distal end and a second concave/convex cross-section;
a first tape guide, said first tape guide having first and second guide slots, said first and second slots being sized and shaped to fit slidably about said first and second tapes and disposed to position said first outer surface adjacent said second outer surface;
at least one second tape guide, said second tape guide having third and fourth guide slots, said third and fourth slots being sized and shaped to fit slidably about said first and second tapes and disposed to position said first outer surface adjacent said second outer surface;
said first tape being slidably connected adjacent said first end to said second tape adjacent said distal end;
a drive system, said drive system having a mounting for said first tape guide, said mounting disposing said first tape guide orthogonal to first and second lengths of said first and second tapes, respectively, having rolled storage for said first and second tapes and having driving members for extending and retracting said first and second tapes through said first and at least one second tape guide; and
said first and second tapes being directed through said first tape guide and said at least one second tape guides and being either of extended and retracted by said drive system.

19. The linear drive mechanism, as described in claim 18, wherein said drive system further comprises:
a drive base, said drive base providing a bearing surface for said linear drive mechanism;
a tape reel, said reel being mounted on a bearing in said drive base and providing said rolled storage for said first tape and said second tape;
a drive roller assembly, said drive roller assembly being disposed within said drive base adjacent said tape reel, having a first drive surface engaging said first inner surface and being driven in either of a first and a second rotational direction by a drive motor;
an idler roller assembly, said idler roller assembly being disposed within said drive base, having a second drive surface engaging said second inner surface and being movable toward and away from said second inner surface; and
said drive roller assembly, idler roller assembly and said drive motor comprising said driving members.

20. The linear drive mechanism, as described in claim 18, further comprising:
an external tubing member, said external member having a first end and a second end, said second end being sized and shaped to attach to said drive system;
a series of nested internal tubing members, each of said internal members having a proximate end and a distal end;
said proximate end of a largest of said internal tubing members being restricted from passing through said first end of said external tubing member;
said proximate end of each succeeding smaller internal tubing member being restricted from passing through said distal end of an internal tubing member within which it is immediately nested;
one of said at least one second tape guides being centrally attached adjacent either of said proximate end and said distal end;
an end cap, said end cap attached to either of a proximal end and a distal end of a smallest of said internal tubing members and attaching to at least one of said first end of said first tape and said distal end of said second tape; and
at least one of said first and second tapes urging said end cap either of toward and away from said drive system as said first and second tapes are either of extended and retracted, said end cap either of extending or retracting said at least one internal tubing member from said external tubing member and said drive system.

21. The linear drive mechanism, as described in claim 20, further comprising:
a first sleeve bearing, said first sleeve bearing being disposed adjacent said first end of said external tubing member, being sized and shaped to fit slidably about said largest internal tubing member and having a first internal diameter;
at least one base bearing, said base bearing being disposed adjacent said proximal end of said internal tubing member, being sized and shaped to fit slidably within either of said external tubing member and a preceding, larger internal tubing member within which said internal tubing member is immediately nested;
at least one second sleeve bearing, said second sleeve bearing being disposed adjacent said distal end of said internal tubing member, being sized and shaped to fit slidably about a subsequent, smaller internal tubing member nested immediately within said internal tubing member and having an internal diameter;
said base bearing having an external diameter larger than either of said first internal diameter and said internal diameter of said second sleeve bearing of said internal tubing member within which said subsequent, smaller internal tubing member to which said base bearing is attached is immediately nested; and
said first and second sleeve bearings and said base bearings preventing disassembly of said external tubing member and said series of nested internal tubing members during extension of said first and second tapes from said drive mechanism.

22. The linear drive mechanism, as described in claim 21, wherein one of said at least one second tape guides is centrally attached to said base bearing.

23. The linear drive mechanism, as described in claim 19, wherein said idler roller assembly further comprises:
a roller support body, said support body having an axel upon which an idler roller is rotatably mounted;
a compression spring, said compression spring urging said support body toward said second inner surface; and
an adjusting screw threadedly engaging either of said support body and said drive base, said adjusting screw varying preloading of said compression spring.

24. The linear drive mechanism, as described in claim 19, further comprising:
at least one tape support, said support being attached to said drive base adjacent said reel and providing a bearing surface adjacent at least one of said first inner surface and said second inner surface; and
said tape support preventing buckling of at least one of said first and second tapes under load.

25. The linear drive mechanism, as described in claim 19, wherein said first and second drive surfaces are formed of resilient material selected from the group comprising:
rubber, silicone, plastic, leather and fabric.

26. The linear drive mechanism, as described in claim 18, wherein said first tape further comprises a series of uniform sprocket holes adjacent at least one of said first near side edge and said first far side edge and said second tape further includes a mating series of uniform sprocket holes adjacent at least one of said second near side edge and said second far side edge.

27. The linear drive mechanism, as described in claim 26, wherein said first drive surface further comprises at least one series of uniform sprocket projections, said sprocket projections being sized, shaped and disposed to engage said sprocket holes in said first tape and said mating series of uniform sprocket holes in said second tape.

28. The linear drive mechanism, as described in claim 27, wherein said second drive surface comprises at least one of either of a series of uniform sprocket detents and a receiving groove, said sprocket detents and said groove being sized, shaped and disposed to receive said at least one series of uniform sprocket projections.

29. The linear drive mechanism, as described in claim 1, further comprising:
at least one expandable bellows section, said bellows section being formed of resilient material and having a proximal end, a distal end and a central axis;
at least one of said expandable bellows sections having one of said second tape guides attached at one of said proximal end and said distal end; and
said first and second tapes extending from said drive system through said at least one expandable bellows section along said central axis and at least one of said first and second tapes urging either of expansion and contraction of said bellows section upon either of extension and retraction of said first and second tapes from said drive system.

30. The linear drive mechanism, as described in claim 18, further comprising:
a tubing section, said tubing section having a hollow bore, a proximal end, a distal end and being attached at said proximal end to said drive system;
a piston, said piston having an inner face and an outer face, being sized, shaped and disposed to fit sealably within said hollow bore and being attached at said inner face to at least one of said second end of said first tape and said distal end of said second tape;
at least one stabilizer, said stabilizer having an aperture and an attachment point and being sized, shaped and disposed to fit slidably within said hollow bore and having one of said at least one second tape guides attached so as to orient said stabilizer orthogonally to said first and second tapes and to said hollow bore;
a spacing member, said spacing member having an outboard end and an inboard end and being attached at said outboard end to either of said inner face of said piston and said attachment point of said at least one stabilizer;
said spacing member being sized, shaped and disposed to pass slidably through said aperture in another of said at least one stabilizer and having a stopping portion at said inboard end, said stopping portion preventing said inboard end from passing through said aperture;
said first and second tapes extending from said drive system through said at least one stabilizer along said hollow bore and at least one of said first and second tapes urging either of extension and retraction of said piston and displacement of said at least one stabilizer within said hollow bore upon either of extension and retraction of said first and second tapes from said drive system.

31. The linear drive mechanism, as described in claim 18, further comprising:
a linear track, said track extending outwardly from said drive system;
at least one truck, said truck having a mounting feature, an aperture, an attachment point, an inner end and an outer end and being sized, shaped and disposed to move slidably along said linear track;
said at least one truck having one of said at least one second tape guides attached so as to orient said truck orthogonally to said first and second tapes and to said linear track;
a spacing ribbon, said spacing ribbon having an outboard end and an inboard end and being attached at said outboard end to said attachment point of said at least one truck;
said spacing ribbon being sized, shaped and disposed to pass slidably through said aperture in another of said at least one truck and having a stopping portion at said inboard end, said stopping portion preventing said inboard end from passing through said aperture;
an outermost truck being attached at said inner end to at least one of said second end of said first tape and to said distal end of said second tape;
said first and second tapes extending from said drive system through said at least one second tape guide attached to said at least one truck along said linear track and at least one of said first and second tapes urging displacement of said at least one truck along said linear track upon either of extension and retraction of said first and second tapes from said drive system, said mounting feature causing displacement of an item mounted thereto.

32. The linear drive mechanism, as described in claim 18, further comprising:
at least one additional linear drive mechanism; said additional drive mechanism being disposed adjacent said linear drive mechanism and having first and second tapes of said additional drive mechanism parallel to first and second tapes of said linear drive mechanism;
an external tubing member, said external member having a first end and a second end, said second end being sized and shaped to enclose said linear drive mechanism and said at least one additional linear drive mechanism;
a series of nested internal tubing members, each of said internal members having a proximate end and a distal end;
said proximate end of a largest of said internal tubing members being restricted from passing through said first end of said external tubing member;
said proximate end of each succeeding smaller internal tubing member being restricted from passing through said distal end of an internal tubing member within which it is immediately nested;
at least two of said second tape guides being centrally attached adjacent either of said proximate end and said distal end;
an end cap, said end cap attached to either of a proximal end and a distal end of a smallest of said internal tubing members and attaching to at least one of said first end of said first tape and said distal end of said second tape of said linear drive mechanism and attaching to said first end of said first tape and said distal end of said second tape of said at least one additional linear drive mechanism; and
at least one of said first and second tapes urging said end cap either of toward and away from said drive systems as said first and second tapes are either of extended and retracted, said end cap either of extending or retracting said at least one internal tubing member from said external tubing member and said drive systems.

33. The linear drive mechanism, as described in claim 32, further comprising:
a first sleeve bearing, said first sleeve bearing being disposed adjacent said first end of said external tubing member, being sized and shaped to fit slidably about said largest internal tubing member and having a first internal diameter;
at least one base bearing, said base bearing being disposed adjacent said proximal end of said internal tubing member, being sized and shaped to fit slidably within either of said external tubing member and a preceding, larger internal tubing member within which said internal tubing member is immediately nested;
at least one second sleeve bearing, said second sleeve bearing being disposed adjacent said distal end of said internal tubing member, being sized and shaped to fit slidably about a subsequent, smaller internal tubing member nested immediately within said internal tubing member and having an internal diameter;
said base bearing having an external diameter larger than either of said first internal diameter and said internal diameter of said second sleeve bearing of said internal tubing member within which said subsequent, smaller internal tubing member to which said base bearing is attached is immediately nested; and
said first and second sleeve bearings and said base bearings preventing disassembly of said external tubing member and said series of nested internal tubing members during extension of said first and second tapes from said drive mechanism.

34. The linear drive mechanism, as described in claim 33, wherein one of said at least one second tape guides is centrally attached to said base bearing.
